(19) United States
(12) Patent Application Publication
(10) Pub. No.: US 2017/0250618 A1
(43) Pub. Date: Aug. 31, 2017

(54) Extremely-Sparse Parallel AC-Link Power Converter

(71) Applicant: The Board of Trustees of the University of Illinois, Urbana, IL (US)

(72) Inventor: Mahshid AMIRABADI, Lexington, MA (US)

(21) Appl. No.: 15/507,819

(22) PCT Filed: Sep. 2, 2015
(86) PCT No.: PCT/US15/48014

§ 371 Date: Mar. 1, 2017

Related U.S. Application Data
(60) Provisional application No. 62/044,693, filed on Sep. 2, 2014.

(51) Int. Cl. H02M 5/458; H02M 1/084

(52) U.S. Cl. CPC H02M 5/458; H02M 1/084; H02M 2001/0058

(57) ABSTRACT

An extremely-sparse parallel AC-link universal power conversion device is provided that is capable of converting between various power schemas using a reduced number of switches. The number of heat-dissipating elements and the overall size of the power converter are reduced, while the power density is increased. The expected failure rate is lowered, increasing the reliability of the power conversion device and reducing maintenance frequency and operating cost.

### CROSS REFERENCE TO RELATED APPLICATIONS

This application claims priority under 35 §119(e) of U.S. Provisional Application No. 62/044,693 filed on Sep. 2, 2014, entitled “Extremely-Sparse Parallel AC-Link Power Converter”, the disclosure of which is hereby incorporated by reference.

### STATEMENT REGARDING FEDERALLY SPONSORED RESEARCH OR DEVELOPMENT

N/A

### BACKGROUND

In the modern era, electrically-powered devices have become ubiquitous. A power source for an electrically-powered device often has a set of static characteristics—such as a voltage level, a minimum or maximum current, and a frequency—that do not align with those required by the device. As one example, a source voltage may need to be reduced to safely power a given device. As another example, a power source utilizes alternating current (AC) while a given device requires direct current (DC) power. Accordingly, a power converting device is required to convert power from a power source to have characteristics compatible with an electrical device.

In some instances, a DC power source will have a voltage level that is different from the voltage level required by a DC-powered device, and a buck or boost converter may be employed to provide the necessary voltage conversion. In other instances, an AC power source will have a voltage level that is different from the voltage level required by an AC-powered device, and a transformer may be employed to provide the necessary change in voltage. In further instances, an AC power source may be used to power a DC-powered device, and a rectifier may be employed to provide the AC-DC conversion. In yet further instances, a DC power source may be used to power an AC-powered device, and an inverter may be employed to provide the DC-AC conversion. However, these power conversion techniques may only be applied in a particular conversion between DC-DC, AC-AC, AC-DC, or DC-AC. Additionally, such power converters require large components, and thus suffer from a relatively low power density.

Some power converters utilize switches—typically in the form of bipolar transistors or field effect transistors (FETs) or Insulated Gate Bipolar Transistor (IGBT)—in order to control the type of power conversion (e.g. DC-DC, AC-AC, AC-DC, and DC-AC), the voltage change, and the frequency change, among other power characteristics. These switches, when coupled with diodes, can be configured to facilitate rectification, inversion, or simply allow current to flow without changing its frequency. These power converters typically involve one or more reactive components that facilitate the change in voltage in a similar manner as buck or boost converters. While such power converters provide a more universal control over the type of power conversion, the switches increase the failure rate of the power converter. Depending on the desired power conversion, a single switch failure may prevent the power converter from operating correctly.

### SUMMARY OF THE INVENTION

The invention relates to power converters that are capable of converting between various power schemas using a reduced number of switches. Reducing the number of switches reduces the number of heat-dissipating elements and the overall size of the power converter while also increasing the power density. Fewer switches also lower the expected failure rate, increasing the reliability of the power converter, and reducing maintenance frequency and operating cost.

In one embodiment, an extremely-sparse parallel AC-link universal power converter includes a power source, an input bridge stage, an input-side crossover switching circuit, an AC-link, an output-side crossover bridge circuit, an output switching bridge stage, and a load. An input-side decoupling circuit and an output-side decoupling circuit may also be included in the power converter, depending on the desired power conversion. The power source may be a DC power source, a single-phase AC power source, or a poly-phase AC power source.

The load may accept any of DC current, single-phase AC current, or poly-phase current, depending on the desired power conversion or load device characteristics.

Other aspects of the method and system include the following:

1. A power conversion device comprising:

at least one input bridge stage comprising a plurality of uncontrollable forward-conducting reverse-blocking devices, wherein the at least one input bridge stage is configured to be coupled to a power source;

a link stage comprising at least one reactive component of a partially resonant circuit, wherein the partially resonant circuit is configured for alternating-current (AC) operation;

at least one output switch bridge stage comprising a plurality of controllable forward-conducting forward-blocking switching devices or controllable forward-conducting bidirectional-blocking switching devices, wherein the at least one output switch bridge stage is configured to be coupled to a load and control current output to the load;

a crossover switching circuit coupling the at least one input bridge stage to the link stage, wherein the crossover switching circuit comprises a plurality of controllable forward-conducting forward-blocking switching devices or controllable forward-conducting bidirectional-blocking switching devices, and wherein the crossover switching circuit is configured to control current from the at least one input bridge stage to the link stage and allow the link current to be alternating; and

a crossover bridge circuit coupling the link stage to the at least one output switch bridge stage, wherein the crossover bridge circuit comprises a bridge of uncontrollable forward-conducting reverse-blocking devices, and wherein the crossover bridge circuit is configured to allow the link current to be alternating.

2. The device of item 1, wherein the link stage comprises at least one reactive component of a partially resonant parallel inductor-capacitor (LC) circuit.
3. The device of any of items 1-2, wherein the at least one reactive component of a partially resonant parallel LC circuit comprises a capacitor, and wherein the partially resonant parallel LC circuit is formed by capacitance of the capacitor together with parasitic inductance of the capacitor.
4. The device of any of items 1-3, wherein the at least one reactive component of a partially resonant parallel LC circuit comprises an inductor, and wherein the partially resonant parallel LC circuit is formed by inductance of the inductor together with parasitic capacitance of the inductor.
5. The device of any of items 1-4, wherein the partially resonant parallel LC circuit comprises an inductor connected in parallel with a capacitor, and wherein the partially resonant parallel LC circuit is formed by inductance of the inductor together with capacitance of the capacitor.
6. The device of any of items 1-5, wherein the at least one reactive component of a partially resonant circuit comprises a galvanic isolation device, wherein the partially resonant circuit further comprises a first capacitive device connected in parallel to an input of the galvanic isolation device and a second capacitive device connected in parallel to an output of the galvanic isolation device, and wherein the partially resonant circuit is formed by inductance of the galvanic isolation device together with capacitance of the first capacitive device and the second capacitive device.
7. The device of any of items 1-6, wherein the power source comprises at least one of the following: a three-phase AC power source, a single-phase AC source, a DC source, and a polyphase AC-source.
8. The device of any of items 1-7, wherein the partially resonant circuit has a resonant frequency that is greater than a frequency of the power source.
9. The device of any of items 1-8, wherein the at least one input bridge stage comprises a diode or a bridge of an even number of diodes configured to form a bridge circuit.
10. The device of any of items 1-9, wherein the at least one input bridge stage comprises six diodes configured to form a three-phase bridge circuit.
11. The device of any of items 1-10, wherein the output crossover bridge circuit comprises a bridge of four diodes configured to form a bridge circuit.
12. A power conversion circuit comprising:

a first diode bridge circuit comprising one diode or an even number of diodes configured to form a bridge circuit;

a partially resonant link circuit comprising at least one capacitive element and at least one inductive element connected in parallel;

a first switch bridge circuit comprising one switch or an even number of switches configured to form a switched bridge circuit;

a second switch bridge circuit coupling the first diode bridge circuit to the partially resonant link circuit, wherein the second switch bridge comprises four switches configured to form a switched bridge circuit; and

a second diode bridge circuit coupling the partially resonant link circuit to the first switch bridge circuit, wherein the second diode bridge circuit comprises four diodes configured to form a bridge circuit.

13. The circuit of item 12, wherein the first diode bridge circuit comprises six diodes.
14. The circuit of any of items 12-13, wherein the first switch bridge circuit comprises six switches.
15. The circuit of any of items 12-14, further comprising a power source connected to the first diode bridge circuit.
16. The circuit of any of items 12-15, further comprising a load connected to the first switch bridge circuit.
17. The circuit of any of items 12-16, wherein the at least one capacitive element is a capacitor.
18. The circuit of any of items 12-17, wherein the at least one inductive element is an inductor.
19. The circuit of any of items 12-18, wherein the at least one inductive element is a single-phase transformer.
20. The circuit of any of items 12-19, wherein each switch of the first switch bridge circuit and the second switch bridge circuit comprises a field effect transistor (FET), an Insulated Gate Bipolar Transistor (IGBT), a diode in series with a field effect transistor (FET), or a diode in series with an Insulated Gate Bipolar Transistor (IGBT).
21. A method of operating a power conversion circuit comprising an input bridge stage, a link stage, an output switch bridge stage, a crossover switching circuit coupling the input bridge stage to the link stage, and a crossover bridge circuit coupling the link stage to the output switch bridge stage, wherein the method comprises:

operating the crossover switching circuit to charge a reactive component of the link stage by turning on the switches of the crossover switching circuit to facilitate a positive current flow;

blocking current flow from the input bridge stage to the link stage by turning off one or more switches of the crossover switching circuit to allow the link stage to resonate; and

operating the output switch bridge stage to discharge the reactive component of the link stage by turning on one or more switches of the output switch bridge stage.

22. The method of item 21, further comprising:

operating the crossover switching circuit to charge a reactive component of the link stage by turning on the switches of the crossover switching circuit to facilitate a negative current flow.

23. The method of any of items 21-22, wherein turning on one or more switches of the output switch bridge stage is performed in response to a voltage of the link stage being zero.
24. A power conversion device comprising:

at least one input bridge stage comprising a plurality of uncontrollable forward-conducting reverse-blocking devices, wherein the at least one input bridge stage is configured to be coupled to a power source;

a link stage comprising at least one reactive component of a partially resonant circuit, wherein the partially resonant circuit is configured for alternating-current (AC) operation;

a crossover switching circuit coupling the at least one input bridge stage to the link stage, wherein the crossover switching circuit comprises a plurality of controllable forward-conducting forward-blocking devices or controllable forward-conducting bidirectional-blocking devices, and wherein the crossover switching circuit is configured to control current from the at least one input bridge stage to the link stage and allow the link current to be alternating; and

a crossover bridge circuit coupling the link stage to a DC load, wherein the crossover bridge circuit comprises a bridge of uncontrollable forward-conducting reverse-blocking devices, and wherein the crossover bridge circuit is configured to allow the link current to be alternating.

25. The power conversion device of item 24, further comprising at least one output switch configured to be coupled between the crossover bridge circuit and the DC load and configured to control current output to the load.
26. The device of any of items 24-25, wherein the link stage comprises at least one reactive component of a partially resonant parallel inductor-capacitor (LC) circuit.
27. The device of any of items 24-26, wherein the at least one reactive component of a partially resonant parallel LC circuit comprises a capacitor, and wherein the partially resonant parallel LC circuit is formed by capacitance of the capacitor together with parasitic inductance of the capacitor.
28. The device of any of items 24-27, wherein the at least one reactive component of a partially resonant parallel LC circuit comprises an inductor, and wherein the partially resonant parallel LC circuit is formed by inductance of the inductor together with parasitic capacitance of the inductor.
29. The device of any of items 24-28, wherein the partially resonant parallel LC circuit comprises an inductor connected in parallel with a capacitor, and wherein the partially resonant parallel LC circuit is formed by inductance of the inductor together with capacitance of the capacitor.
30. The device of any of items 24-29, wherein the at least one reactive component of a partially resonant circuit comprises a galvanic isolation device, wherein the partially resonant circuit further comprises a first capacitive device connected in parallel to an input of the galvanic isolation device and a second capacitive device connected in parallel to an output of the galvanic isolation device, and wherein the partially resonant circuit is formed by inductance of the galvanic isolation device together with capacitance of the first capacitive device and the second capacitive device.
31. The device of any of items 24-30, wherein the power source comprises at least one of the following: a three-phase AC power source, a single-phase AC source, a DC source, and a polyphase AC-source.
32. The device of any of items 24-31, wherein the partially resonant circuit has a resonant frequency that is greater than a frequency of the power source.
33. The device of any of items 24-32, wherein the at least one input bridge stage comprises a diode or a bridge of an even number of diodes configured to form a bridge circuit.
34. The device of any of items 24-33, wherein the at least one input bridge stage comprises six diodes configured to form a three-phase bridge circuit.
35. The device of any of items 24-34, wherein the output crossover bridge circuit comprises a bridge of four diodes configured to form a bridge circuit.
36. A power conversion device comprising:

at least one input bridge stage comprising a plurality of controllable forward-conducting reverse-blocking or controllable forward-conducting bidirectional-blocking switching devices, wherein the at least one input bridge stage is configured to be coupled to a power source;

a link stage comprising at least one reactive component of a partially resonant circuit, wherein the partially resonant circuit is configured for alternating-current (AC) operation;

a crossover switching circuit coupling the at least one input bridge stage to the link stage, wherein the crossover switching circuit comprises a plurality of controllable forward-conducting forward-blocking or controllable forward-conducting bidirectional-blocking switching devices, and wherein the crossover switching circuit is configured to control current from the at least one input bridge stage to the link stage and allow the link current to be alternating; and

a crossover bridge circuit coupling the link stage to a DC load, wherein the crossover bridge circuit comprises a bridge of uncontrollable forward-conducting reverse-blocking devices, and wherein the crossover bridge circuit is configured to allow the link current to be alternating.

37. The power conversion device of item 36, further comprising at least one output switch configured to be coupled between the crossover bridge circuit and the a DC load and configured to control current output to the DC load;
38. The device of any of items 36-37, wherein the link stage comprises at least one reactive component of a partially resonant parallel inductor-capacitor (LC) circuit.
39. The device of any of items 36-38, wherein the at least one reactive component of a partially resonant parallel LC circuit comprises a capacitor, and wherein the partially resonant parallel LC circuit is formed by capacitance of the capacitor together with parasitic inductance of the capacitor.
40. The device of any of items 36-39, wherein the at least one reactive component of a partially resonant parallel LC circuit comprises an inductor, and wherein the partially resonant parallel LC circuit is formed by inductance of the inductor together with parasitic capacitance of the inductor.
41. The device of any of items 36-40, wherein the partially resonant parallel LC circuit comprises an inductor connected in parallel with a capacitor, and wherein the partially resonant parallel LC circuit is formed by inductance of the inductor together with capacitance of the capacitor.
42. The device of any of items 36-41, wherein the at least one reactive component of a partially resonant circuit comprises a galvanic isolation device, wherein the partially resonant circuit further comprises a first capacitive device connected in parallel to an input of the galvanic isolation device and a second capacitive device connected in parallel to an output of the galvanic isolation device, and wherein the partially resonant circuit is formed by inductance of the galvanic isolation device together with capacitance of the first capacitive device and the second capacitive device.
43. The device of any of items 36-42, wherein the power source comprises at least one of the following: a three-phase AC power source, a single-phase AC source, a DC source, and a polyphase AC-source.
44. The device of any of items 36-43, wherein the partially resonant circuit has a resonant frequency that is greater than a frequency of the power source.
45. The device of any of items 36-44, wherein the output crossover bridge circuit comprises a bridge of four diodes configured to form a bridge circuit.
46. A power conversion device comprising:

at least one input bridge stage comprising a plurality of controllable bidirectional-conducting bidirectional-blocking switching devices, wherein the at least one input bridge stage is configured to be coupled to a power source;

a link stage comprising at least one reactive component of a partially resonant circuit, wherein the partially resonant circuit is configured for alternating-current (AC) operation; and

a crossover bridge circuit coupling the link stage to a DC load, wherein the crossover bridge circuit comprises a bridge of uncontrollable forward-conducting reverse-blocking devices, and wherein the crossover bridge circuit is configured to allow the link current to be alternating.

47. The power conversion device of item 46, further comprising at least one output switch configured to be coupled between the crossover bridge circuit and the DC load and configured to control current output to the DC load.
48. The device of any of items 46-47, wherein the link stage comprises at least one reactive component of a partially resonant parallel inductor-capacitor (LC) circuit.
49. The device of any of items 46-48, wherein the at least one reactive component of a partially resonant parallel LC circuit comprises a capacitor, and wherein the partially resonant parallel LC circuit is formed by capacitance of the capacitor together with parasitic inductance of the capacitor.
50. The device of any of items 46-49, wherein the at least one reactive component of a partially resonant parallel LC circuit comprises an inductor, and wherein the partially resonant parallel LC circuit is formed by inductance of the inductor together with parasitic capacitance of the inductor.
51. The device of any of items 46-50, wherein the partially resonant parallel LC circuit comprises an inductor connected in parallel with a capacitor, and wherein the partially resonant parallel LC circuit is formed by inductance of the inductor together with capacitance of the capacitor.
52. The device of any of items 46-51, wherein the at least one reactive component of a partially resonant circuit comprises a galvanic isolation device, wherein the partially resonant circuit further comprises a first capacitive device connected in parallel to an input of the galvanic isolation device and a second capacitive device connected in parallel to an output of the galvanic isolation device, and wherein the partially resonant circuit is formed by inductance of the galvanic isolation device together with capacitance of the first capacitive device and the second capacitive device.
53. The device of any of items 46-52, wherein the power source comprises at least one of the following: a three-phase AC power source, a single-phase AC source, a DC source, and a polyphase AC-source.
54. The device of any of items 46-53, wherein the partially resonant circuit has a resonant frequency that is greater than a frequency of the power source.
55. The device of any of items 46-54, wherein the output crossover bridge circuit comprises a bridge of four diodes configured to form a bridge circuit.
56. A power conversion device comprising:

a link stage comprising at least one reactive component of a partially resonant circuit, wherein the partially resonant circuit is configured for alternating-current (AC) operation;

a crossover switching circuit coupling a DC power source to the link stage, wherein the crossover switching circuit comprises a plurality of controllable forward-conducting forward-blocking or controllable forward-conducting bidirectional-blocking switching devices, and wherein the crossover switching circuit is configured to control current from an input source to the link stage and allow the link current to be alternating; and

a crossover bridge circuit coupling the link stage to a DC load, wherein the crossover bridge circuit comprises a bridge of uncontrollable forward-conducting reverse-blocking devices, and wherein the crossover bridge circuit is configured to allow the link current to be alternating.

57. The power conversion device of item 56, further comprising at least one output switch configured to be coupled between the crossover bridge circuit and the DC load and configured to control current output to the DC load.
58. The device of any of items 56-57, wherein the link stage comprises at least one reactive component of a partially resonant parallel inductor-capacitor (LC) circuit.
59. The device of any of items 56-58, wherein the at least one reactive component of a partially resonant parallel LC circuit comprises a capacitor, and wherein the partially resonant parallel LC circuit is formed by capacitance of the capacitor together with parasitic inductance of the capacitor.
60. The device of any of items 56-59, wherein the at least one reactive component of a partially resonant parallel LC circuit comprises an inductor, and wherein the partially resonant parallel LC circuit is formed by inductance of the inductor together with parasitic capacitance of the inductor.
61. The device of any of items 56-60, wherein the partially resonant parallel LC circuit comprises an inductor connected in parallel with a capacitor, and wherein the partially resonant parallel LC circuit is formed by inductance of the inductor together with capacitance of the capacitor.
62. The device of any of items 56-61, wherein the at least one reactive component of a partially resonant circuit comprises a galvanic isolation device, wherein the partially resonant circuit further comprises a first capacitive device connected in parallel to an input of the galvanic isolation device and a second capacitive device connected in parallel to an output of the galvanic isolation device, and wherein the partially resonant circuit is formed by inductance of the galvanic isolation device together with capacitance of the first capacitive device and the second capacitive device.
63. The device of any of items 56-62, wherein the output crossover bridge circuit comprises a bridge of four diodes configured to form a bridge circuit.
64. A power conversion device comprising:

at least one input switch bridge stage comprising a plurality of controllable forward-conducting reverse-blocking or controllable forward-conducting bidirectional-blocking switching devices, wherein the at least one input bridge stage is configured to be coupled to a power source;

a link stage comprising at least one reactive component of a partially resonant circuit, wherein the partially resonant circuit is configured for alternating-current (AC) operation;

at least one output switch bridge stage comprising a plurality of controllable forward-conducting forward-blocking switching devices or controllable forward-conducting bidirectional-blocking switching devices, wherein the output switch bridge stage is configured to be coupled to a load and control current output to the load; and

an intermediate crossover switching circuit coupling the at least one input switch bridge stage to the link stage and coupling the link stage to the at least one output switch bridge stage, wherein the intermediate crossover switching circuit comprises a plurality of forward-conducting bidirectional-blocking switching devices, and wherein the intermediate crossover switching circuit is configured to allow the link current to be alternating.

65. The device of item 64, wherein the link stage comprises at least one reactive component of a partially resonant parallel inductor-capacitor (LC) circuit.
66. The device of any of items 64-65, wherein the at least one reactive component of a partially resonant parallel LC circuit comprises a capacitor, and wherein the partially resonant parallel LC circuit is formed by capacitance of the capacitor together with parasitic inductance of the capacitor.
67. The device of any of items 64-66, wherein the at least one reactive component of a partially resonant parallel LC circuit comprises an inductor, and wherein the partially resonant parallel LC circuit is formed by inductance of the inductor together with parasitic capacitance of the inductor.
68. The device of any of items 64-67, wherein the partially resonant parallel LC circuit comprises an inductor connected in parallel with a capacitor, and wherein the partially resonant parallel LC circuit is formed by inductance of the inductor together with capacitance of the capacitor.
69. The device of any of items 64-68, wherein the at least one reactive component of a partially resonant circuit comprises a galvanic isolation device, wherein the partially resonant circuit further comprises a first capacitive device connected in parallel to an input of the galvanic isolation device and a second capacitive device connected in parallel to an output of the galvanic isolation device, and wherein the partially resonant circuit is formed by inductance of the galvanic isolation device together with capacitance of the first capacitive device and the second capacitive device.
70. The device of any of items 64-69, wherein the power source comprises at least one of the following: a three-phase AC power source, a single-phase AC source, a DC source, and a polyphase AC-source.
71. The device of any of items 64-70, wherein the partially resonant circuit has a resonant frequency that is greater than a frequency of the power source.

### DESCRIPTION OF THE DRAWINGS

The invention will be more fully understood from the following detailed description taken in conjunction with the accompanying drawings in which:

FIG. 1 illustrates a schematic of a partially resonant AC-link universal power converter in accordance with one or more example embodiments;

FIG. 2 illustrates a schematic of a sparse parallel AC-link universal power converter in accordance with one or more example embodiments;

FIG. 3 illustrates a schematic of an ultra-sparse parallel AC-link power converter in accordance with one or more example embodiments;

FIG. 4 illustrates a schematic of an extremely-sparse parallel AC-link power converter in accordance with one or more example embodiments;

FIG. 5 illustrates a schematic of an extremely-sparse parallel AC-link power converter with galvanic isolation in accordance with one or more example embodiments;

FIGS. 6A-6L illustrate example modes of operation of an extremely-sparse parallel AC-link power converter in accordance with one or more example embodiments;

FIG. 7 illustrates example waveforms of the link voltage, link current, input currents, and output currents of the extremely-sparse parallel AC-link power converter operating under the modes of operation in accordance with one or more example embodiments;

FIG. 8 illustrates a schematic of an extremely-sparse parallel AC-link power converter in an AC-DC configuration in accordance with one or more example embodiments;

FIG. 9 illustrates a schematic of an extremely-sparse parallel AC-link power converter in an AC-DC configuration with increased output voltage in accordance with one or more example embodiments;

FIG. 10 illustrates a schematic of an extremely-sparse parallel AC-link power converter having a unidirectional conducting input switch bridge in an AC-DC configuration in accordance with one or more example embodiments;

FIG. 11 illustrates a schematic of an extremely-sparse parallel AC-link power converter having a unidirectional conducting input switch bridge in an AC-DC configuration in accordance with one or more example embodiments;

FIG. 12 illustrates a schematic of an extremely-sparse parallel AC-link power converter having a bidirectional-conducting input switch bridge in an AC-DC configuration in accordance with one or more example embodiments;

FIG. 13 illustrates a schematic of an extremely-sparse parallel AC-link power converter having a bidirectional-conducting input switch bridge in an AC-DC configuration in accordance with one or more example embodiments;

FIG. 14 illustrates a schematic of an extremely-sparse parallel AC-link power converter without an input-side crossover switch bridge in a DC-DC configuration in accordance with one or more example embodiments;

FIG. 15 illustrates a schematic of an extremely-sparse parallel AC-link power converter without an input-side crossover switch bridge with increased output voltage in a DC-DC configuration in accordance with one or more example embodiments;

FIG. 16 illustrates a schematic of an extremely-sparse parallel AC-link power converter with bidirectional current flow in an AC-AC configuration in accordance with one or more example embodiments; and

FIG. 17 illustrates a schematic of an extremely-sparse parallel AC-link power converter with bidirectional current flow in a DC-AC configuration in accordance with one or more example embodiments.

### DETAILED DESCRIPTION OF THE INVENTION

This application incorporates by reference the entire disclosure of U.S. Provisional Application No. 62/044,693 filed on Sep. 2, 2014, entitled “Extremely-Sparse Parallel AC-Link Power Converter”.

Universal power converters—devices that may convert between any of DC power, single-phase AC power, or multi-phase AC power—may be implemented in a wide variety of applications, including wind power generation systems, photovoltaic power generation systems, and electrical vehicle application, among others. Whatever the application may be, it is desired to have a power converter that is not only capable of converting between various power schemas, but also is reliable, inexpensive, small in size, and has a high power density. However, universal power converters typically require many switches; a traditional three-phase parallel AC-link universal converter includes 24 switches. While the three-phase parallel AC-link universal converter is capable of converting between a variety of power schemas, the large number of switches requires more heat-dissipating elements, such as heat sinks, which contribute considerably to the size of the power converter. Reducing the number of switches, therefore, would reduce the number of heat-dissipating elements, thereby reducing the overall size of the power converter. Additionally, if the amount of power output from the converter remains the same but the number of switches are reduced, the resulting power converter has a greater power density compared to the original topology.

Each switch used within a power converter may also have a failure rate characteristic. As the number of switches in a power converter increases, this failure rate is multiplied. Thus, it is desired to minimize the number of switches required, so as to reduce the overall failure rate of the power converter. A lower expected failure rate may increase the reliability of the power converter, thereby reducing maintenance frequency and the cost of operating the power converter over a period of time. Therefore, reducing the number of switches is desired, for at least the reason that the resulting power converter is smaller in size, reduced in weight, more reliable, lower cost, and has an increased power density.

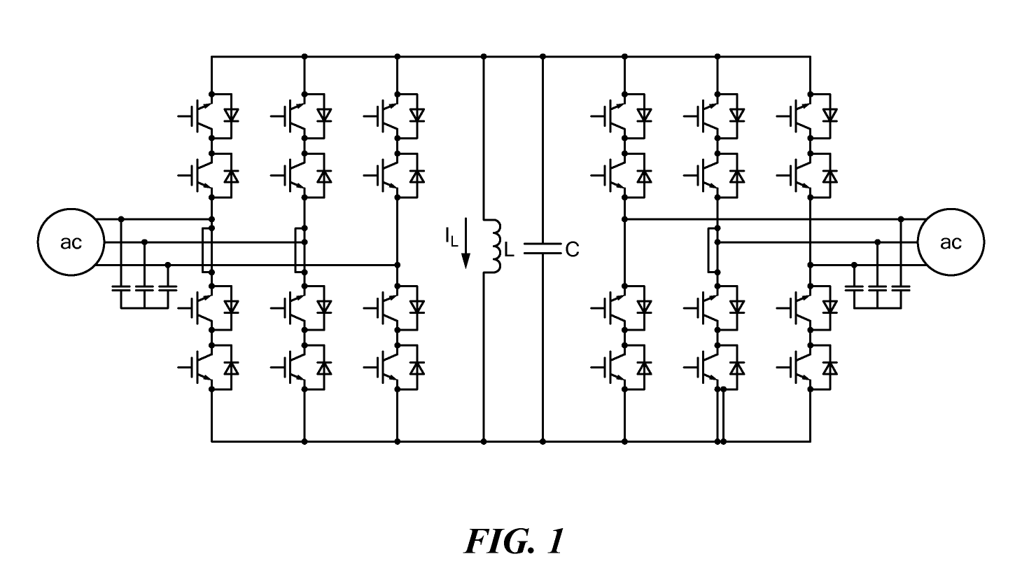

An example topology for an AC-link universal power converter includes an input switch bridge, an AC-link, and an output switch bridge. The input and output switch bridges include bidirectional switches. An example of a partially resonant AC-link universal power converter is depicted in FIG. 1.

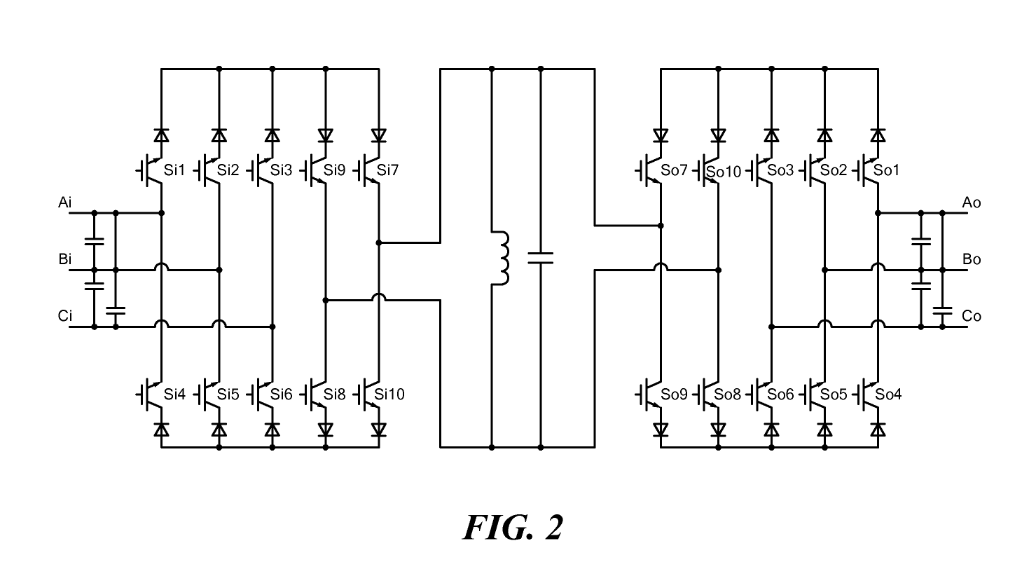

An example topology for a sparse AC-link universal power converter includes an input switch bridge, an AC-link, an output switch bridge, and intermediate crossover switching circuits on the input-side and the output-side to connect the input switch bridge to the AC-link and the AC-link to the output switch bridge. In one embodiment, the input and output switch bridges include unidirectional switches, and the crossover switching circuits provide the AC-link with alternating current and permit the AC-link to operate bidirectionally. The crossover switches may include unidirectional switches similar to those in the input switch bridge and the output switch bridge. The unidirectional switches of the input-side crossover switching circuit are arranged in a bridge configuration. In the example sparse configuration shown in FIG. 2, the current flows down through switches Si7 and Si9 into the AC-link and returns down through Si8 and Si10. The unidirectional switches of the output-side crossover switching circuit are also arranged in a bridge configuration. In the example sparse configuration shown in FIG. 2, the current flows down through So8 and So9 through the output switch bridge and returns down through So7 and So10 back to the AC-link. This topology may be able to provide power conversion between any combination of DC sources and/or loads and single- or poly-phase AC sources and/or loads. In one example, the AC-link is formed with an inductor and a capacitor in parallel, such that charging and discharging the AC-link facilitates soft switching. The above-described topology may be referred to herein as a “sparse parallel AC-link universal power converter,” or more simply as the “sparse configuration.” An example sparse configuration is depicted in FIG. 2.

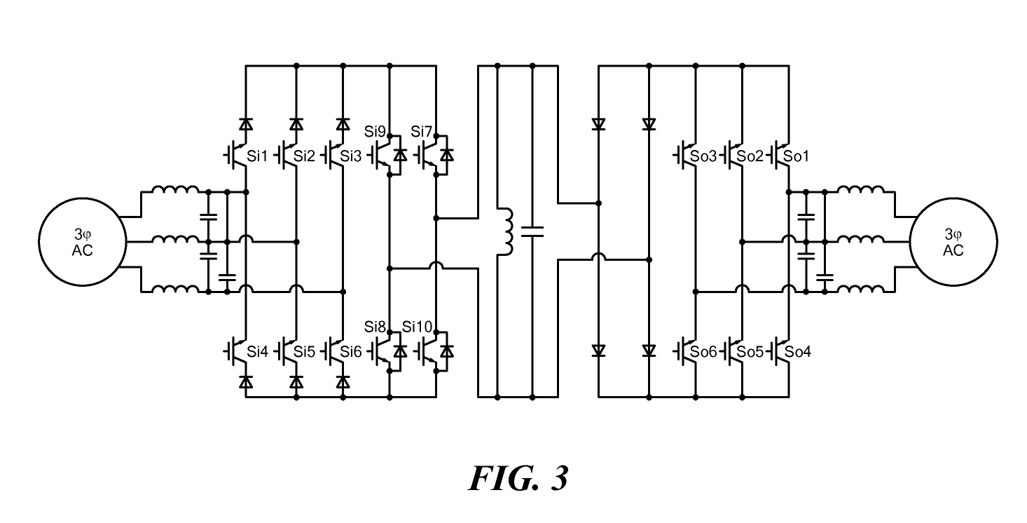

In some instances, it may be desired to reduce the number of switches in a power converter to thereby reduce the failure rate of the converter. One example topology replaces the unidirectional switches in the output-side crossover switching circuit with diodes in the form of a bridge to reduce the number of switches in the power converter. This topology may be referred to herein as an “ultra-sparse parallel AC-link universal power converter,” or more simply as the “ultra-sparse configuration.” An example ultra-sparse configuration is depicted in FIG. 3. While the ultra-sparse configuration provides a benefit of a reduced failure rate, replacing the unidirectional switches with diodes causes the power converter to operate in one direction. Thus, this topology offers a reduced failure rate for applications that do not require bidirectional power flow.

The following descriptions of the extremely-sparse parallel AC-link power converter describe devices that are “controllable” and “uncontrollable.” A controllable device may be a device that can be controlled to act as a switch, such that the device conducts current when switched on and does not conduct current when switched off In some cases, a controllable device may have three or more terminals, with one of the terminals corresponding to an input that may allow or prevent the flow of current through two other terminals. In some embodiments, controllable device may include a bipolar junction transistor or a field effect transistor, among other components. An uncontrollable device may be a device that, unlike a controllable device, does not include a terminal input that controls the flow of current through the device. In some cases, an uncontrollable device may have two or more terminals, with current flowing from one terminal through the other. An uncontrollable device may only conduct in one direction and prevent the flow of current in the opposite direction; this property of an uncontrollable device may be referred to herein as “forward-blocking” or “reverse-blocking” depending upon the orientation of such a device. In some embodiments, the uncontrollable device may include a diode, among other components. It should be noted that a controllable device may also include an uncontrollable device, such that the device's conduction may be controlled while also preventing the flow of current in a particular direction.

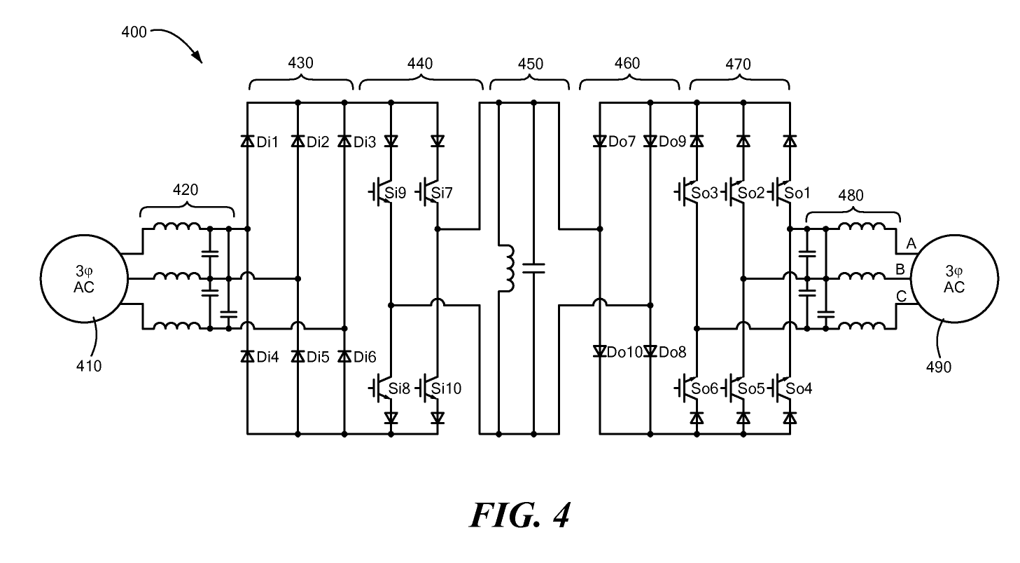

FIG. 4 illustrates an embodiment of a universal power converter with a reduced number of switches. The topology presented in FIG. 4 may be referred to herein as an “extremely-sparse parallel AC-link power converter,” or more simply as the “extremely-sparse configuration.” The extremely-sparse parallel AC-link universal power converter includes a power source 410, input bridge stage 430, input-side crossover switching circuit 440, AC-link 450, output-side crossover bridge circuit 460, output switching bridge stage 470, and load 490. Input-side decoupling circuit 420 and output-side decoupling circuit 480 may also be included in the power converter, depending on the desired power conversion. The power source 410 may be a DC power source, a single-phase AC power source, or a poly-phase AC power source. The load 490 may accept any of DC current, single-phase AC current, or poly-phase current, depending on the desired power conversion or load device characteristics. In some instances, a minimum load power factor may be specified in order for the power converter to operate correctly.

The input bridge stage 430 includes non-controllable forward-conducting reverse-blocking devices, such as diodes, configured to form a three-phase bridge circuit. The AC-link 450 includes a capacitive element and an inductive element connected in parallel. In some instances, the capacitive element and the inductive element in AC-link 450 are two individual reactive elements, such as a capacitor and an inductor. In other instances, a single reactive element has capacitance and an inductance, where one of the capacitance and inductance is parasitic. In further instances, there may be more than one capacitive element and/or more than one inductive element connected in parallel. The output switching bridge stage 470 includes controllable forward-conducting forward-blocking devices, or controllable forward-conducting bidirectional-blocking devices, such as an IGBT or a diode in series with an IGBT, configured to form a three-phase switched bridge rectifier.

The input bridge stage 430 and the AC-link 450 are coupled together with the input-side crossover switching circuit 440. The input-side crossover switching circuit 440 includes controllable forward-conducting forward-blocking devices, such as an IGBT, or forward-conducting bidirectional-blocking such as a diode in series with an IGBT, configured to form a switched bridge circuit. The AC-link 450 and the output switching bridge stage 470 are coupled together with the output-side crossover bridge circuit 460. The output-side crossover bridge circuit 460 includes uncontrollable forward-conducting reverse-blocking devices such as diodes, to form a bridge circuit. When the input-side crossover switching circuit switches 440 are turned on, current flows through the input bridge stage 430 and charges the AC-link 450. Then, when the output switching bridge stage 470 switches are turned on, current flows out of the AC-link 450 through the output-side crossover bridge circuit 460.

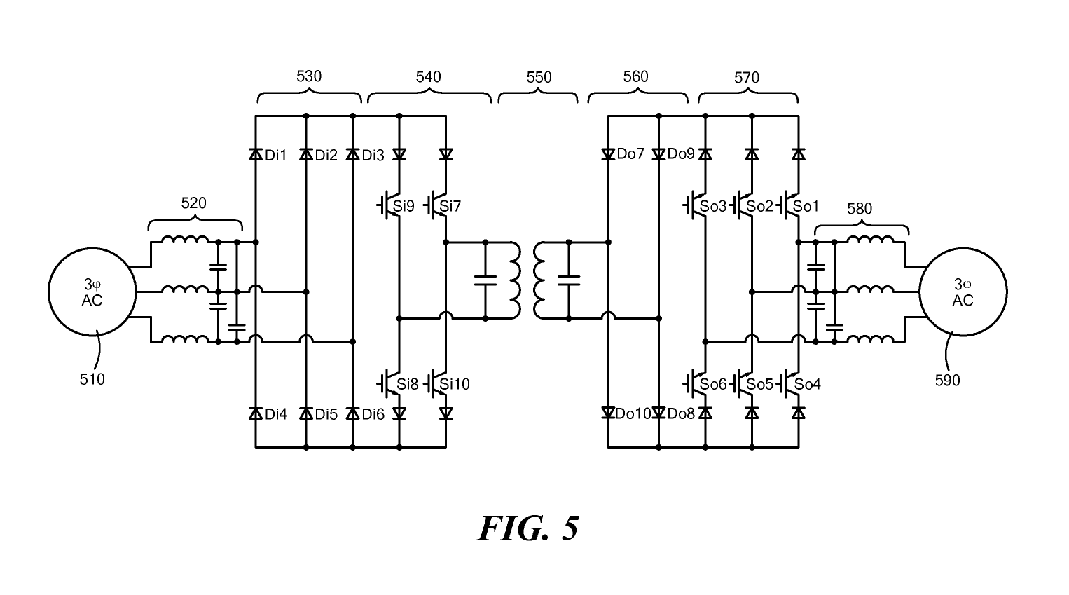

FIG. 5 illustrates an extremely-sparse AC-link power converter similar to the power converter in FIG. 4, but includes galvanic isolation at AC-link 550. Note that each of the power source 510, input-side decoupling circuit 520, input bridge stage 530, input-side crossover switching circuit 540, output-side crossover bridge circuit 560, output switching bridge stage 570, output-side decoupling circuit 580, and load 590 are similar to the power source 410, input-side decoupling circuit 420, input bridge stage 430, input-side crossover switching circuit 440, output-side crossover bridge circuit 460, output switching bridge stage 470, output-side decoupling circuit 480, and load 490, and thus no additional description is provided.

In some instances, the galvanic isolation of AC-link 550 may include a high-frequency transformer. A high-frequency transformer may include inductance that is used as part of the AC-link 550, and capacitors may be placed in parallel on both the input-side and output-side of the transformer to provide the capacitance of the AC-link 550. In one example, the high-frequency transformer also includes parasitic capacitance, such that the combination of the transformer's inductance and parasitic capacitance together form the AC-link 550. Other forms of galvanic isolation may be provided, such as opto-isolation, capacitive coupling, or other forms of magnetic coupling, among others. In those instances, inductive elements and capacitive elements may also be provided to establish the AC-link 550.

In some power conversion applications, galvanic isolation may be desired to prevent dangerous current flow through the power converter in the event of a failure of a reactive component in the AC-link. In some instances, the power converter may be providing many kilo-Watts of power, and the galvanic isolation may be included to prevent power shorts that may damage the power source and/or load.

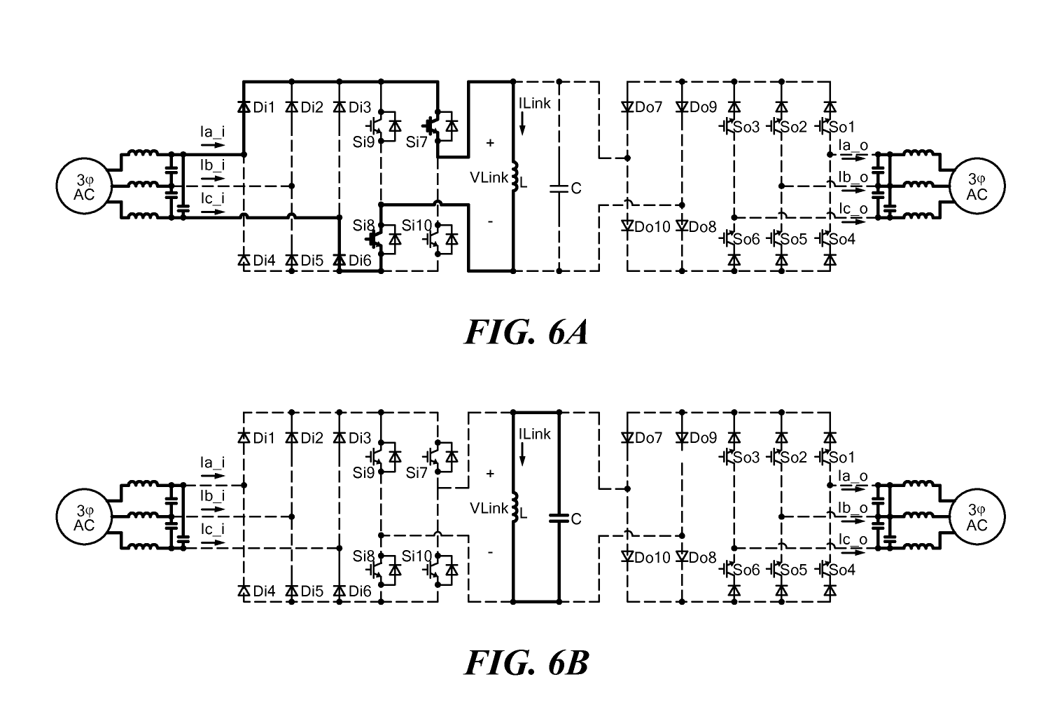

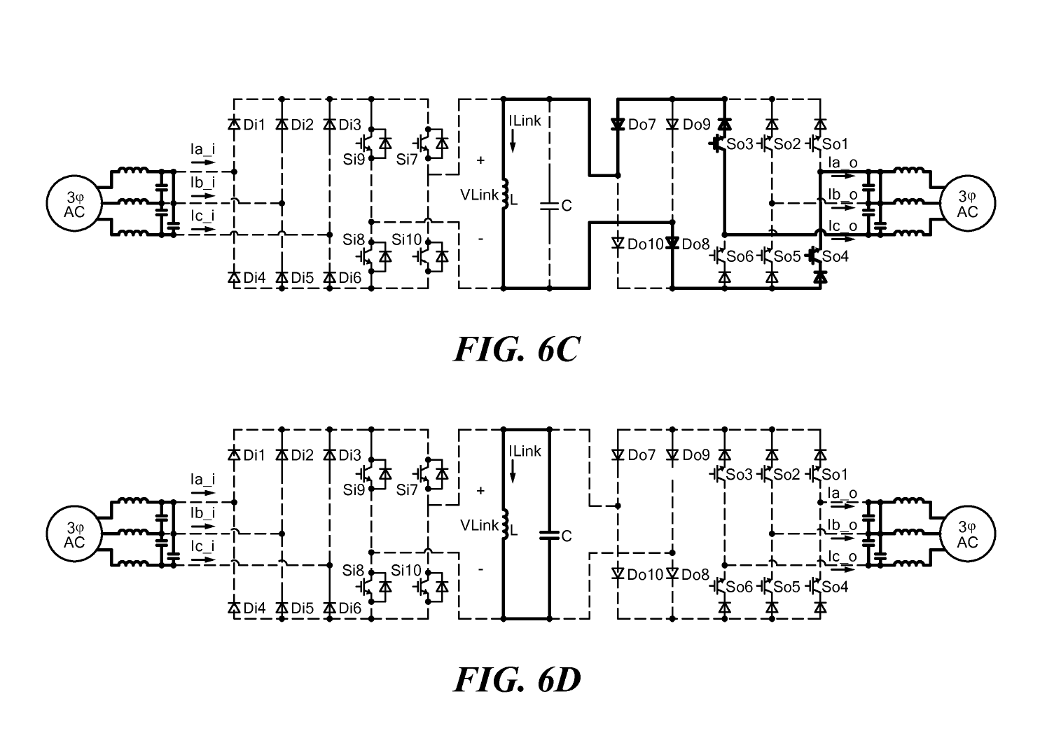

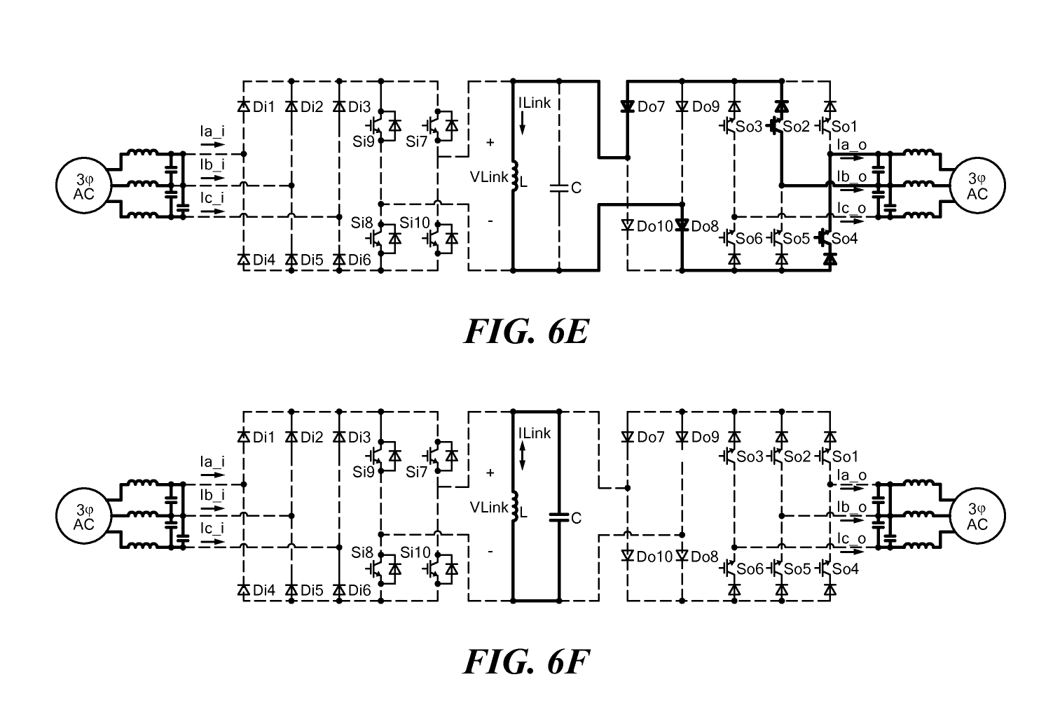

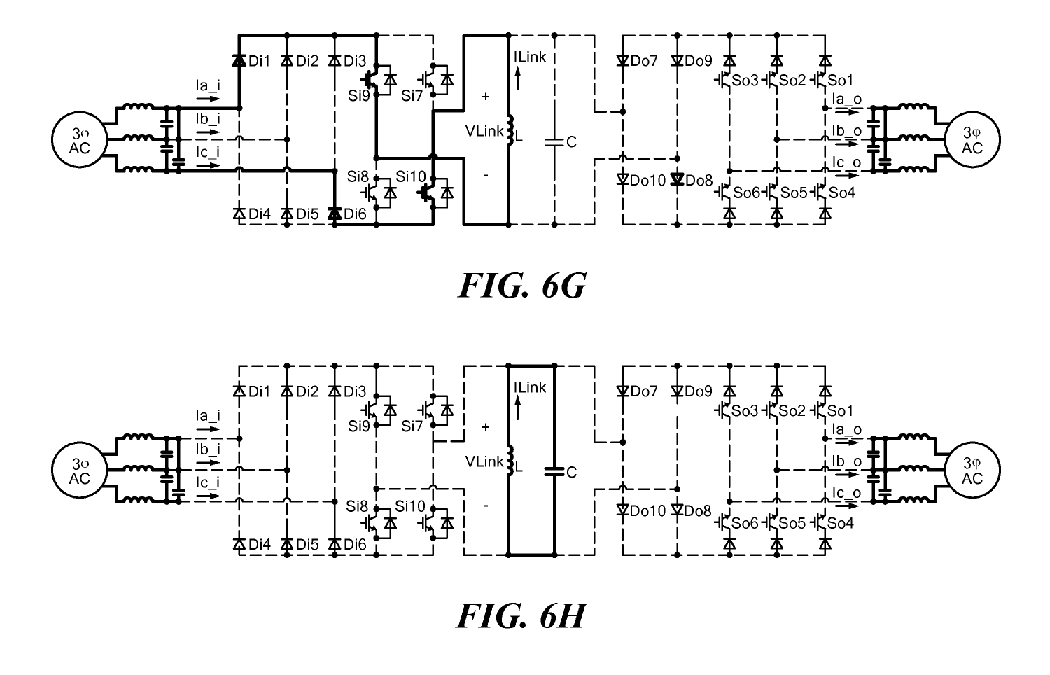

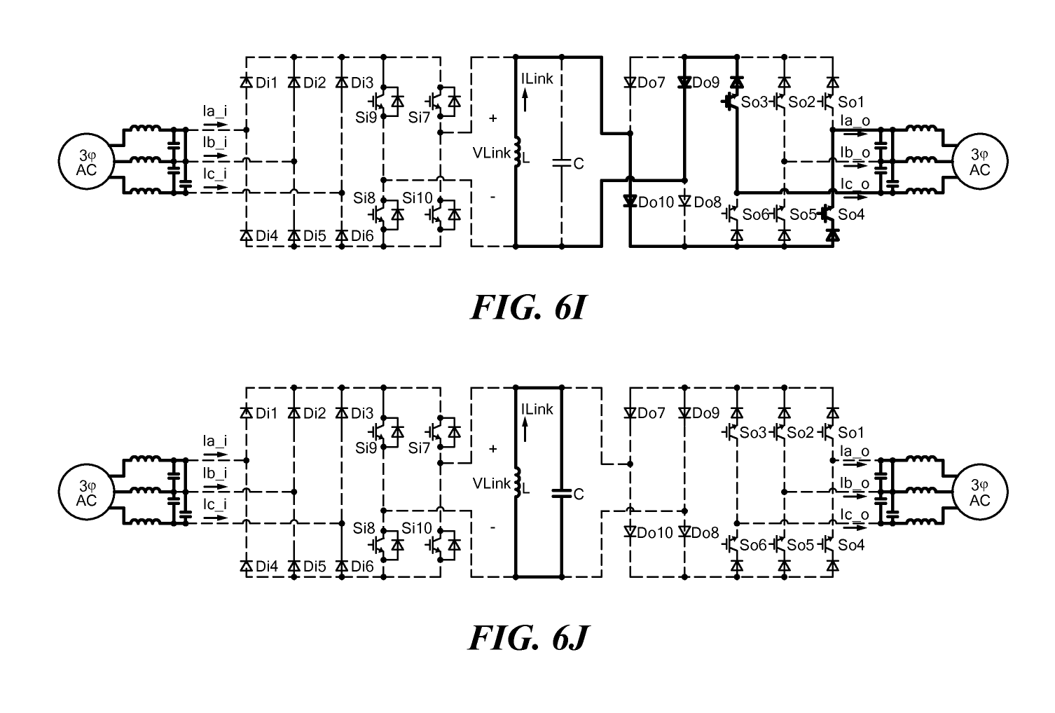

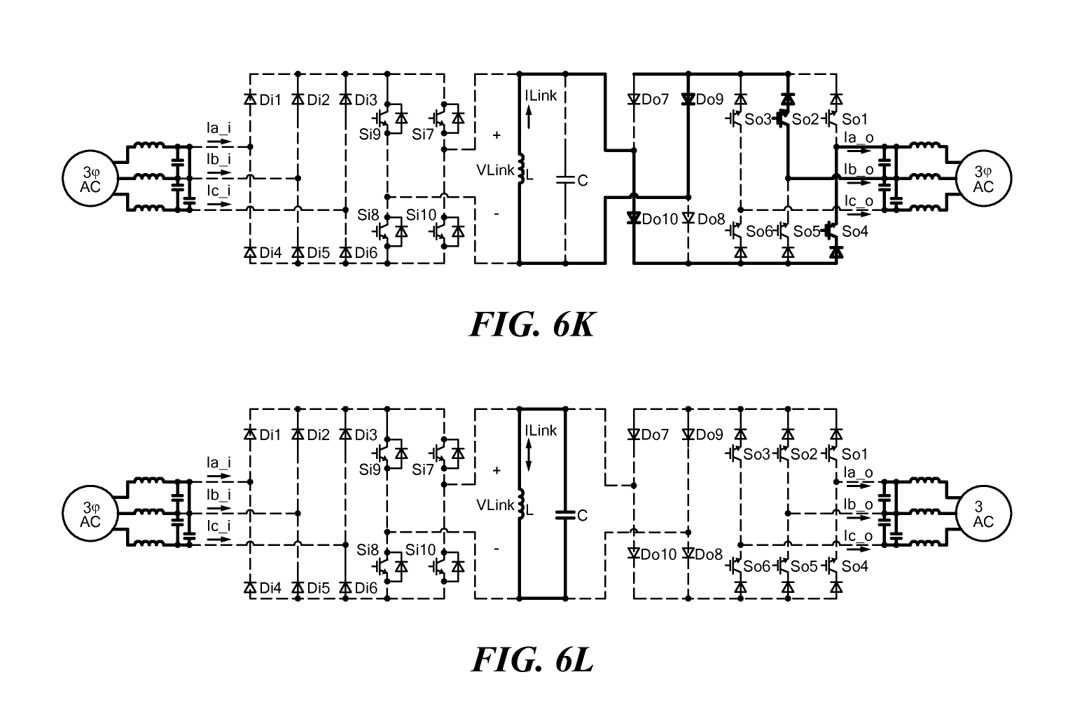

FIGS. 6A-6L depict an example operation of an extremely-sparse AC-link power converter. The three-phase AC to three-phase AC extremely-sparse configuration utilizes 12 modes of operation to facilitate the desired power conversion. The modes of operation include charging the AC-link, resonating the AC-link, and discharging the AC-link. In some instances, the AC-link may be charged with a positive current flowing through the two diodes—or three diodes, in some configurations—at the input bridge and two switches at the input-side crossover switching circuit during the first half cycle of the AC power source. Then, the AC-link resonates to allow for soft switching, where the input-side crossover switching circuit switches are turned off and the output switching bridge stage switches are turned on. Once the proper switches associated with the first discharge mode at the output switching bridge stage are forward biased, the AC-link discharges a positive current through the switches to the load. The cycle then repeats for the second half cycle of the AC power source, charging the AC-link with a negative current, resonating the AC-link, and discharging a negative current from the AC-link to the load. Each of the 12 modes is explained in more detail in later sections.

In some embodiments, a control circuit (not shown in the figures) is used to facilitate the switching of the input-side crossover switching circuit switches and the output switching bridge switches. The control circuit may be, for example, a microcontroller, an FPGA, or an analog circuit, among others. In some instances, the control circuit facilitates soft switching. For example, as depicted in FIG. 6C, the control circuit turns on switches So3 and So4 during the resonating mode depicted in FIG. 6D before becoming forward biased such that, at the end of the resonating mode, the switches immediately become forward biased and begin conducting. The control circuit may determine the switches to turn on based on the value of the AC-link current. Then, the control circuit may determine to turn off those switches when a particular phase current (Iₐ_{_}ᵢ, I_{b}_{_}ᵢ, I_{c}_{_}ᵢ, Iₐ_{_}₀, I_{b}_{_}₀, or I_{c}_{_}₀) associated with the mode of operation meets a reference value. Power losses typically associated with switching may be greatly reduced using this soft switching method.

Generally, an extremely-sparse AC-link power converter conducts current from the power source through the input bridge stage to the input-side crossover switching circuit, which may then conduct current to charge the inductor of the AC-link. When the AC-link is charged, the switches of the input-side crossover link are turned off to prevent the flow of current from the power source to the AC-link, thereby allowing the AC-link LC tank to resonate. The link resonates and when the polarity of the link voltage changes the output switch bridge stage switches are turned on to allow the flow of current from the inductor of the AC-link to the load. Note that, for a three-phase extremely-sparse AC-link power converter, there may be 4 input-side switches and 6 output-side switches that may be controlled to facilitate power conversion. The reduced number of switches in the extremely-sparse configuration—10 compared to 16 in the ultra-sparse configuration—provides a benefit of reduced size and cost, along with increased efficiency, reliability and power density. However, over the duration of the 12 modes of operation, only 2 modes are used for charging the link, whereas 4 modes are used for discharging the link; this is the result of removing the input bridge stage switches found in the sparse configuration and the ultra-sparse configuration. Charging the link is performed with the phase pair having the highest instantaneous voltage. Discharging the link is split into two modes, first with the phase pair having lower absolute value of instantaneous voltage, and then with the phase pair having higher absolute value of the instantaneous voltage. In a balanced three-phase system the current of the phase carrying the maximum instantaneous current is of a certain polarity (positive or negative), which is opposite that of the other two phases. Therefore, only two phase pairs can provide a path for the current. The control circuit may use the voltage of these phase pairs as a basis to determine which switches to turn on during the discharge mode 3 (depicted in FIG. 6C) and which switches to turn on during the discharge mode 5 (depicted in FIG. 6E).

The six switches of the output switch bridge allow the extremely-sparse AC-link power converter to control the current of two output phases (or three phases in a balanced system) during each half cycle (i.e. the first six modes of operation and the last six modes of operation). In the sparse configuration (depicted in FIG. 2) and the ultra-sparse configuration (depicted in FIG. 3) the active switches at the input switch bridge may be operated to control all three phases. In the extremely-sparse configuration, the active switches typically included in the input switch bridge of the sparse or ultra-sparse configurations are replaced with diodes. Although the input bridge diodes cannot be actively controlled, the charging of the link may still be controlled by the switches located at the input-side intermediate cross-over switching circuit. As described above, the charging mode may not be split in two modes in the extremely-sparse configuration. Thus, the extremely-sparse AC-link power converter performs power conversion using 12 modes of operation. In the sparse and ultra-sparse configurations, the particular input phase carrying the maximum current is used to charge the link during modes 1 and 3; similarly, the control circuit may control the switches at the crossover switching circuit of the extremely-sparse configuration according to the current of that particular phase. In some cases, the link current may be used as a basis for controlling Si7-Si10 to reduce the complexity of the control circuit, thus eliminating the need to measure the input-side currents.

In some cases, the total harmonic distortion (THD) may be high at the input-side currents of this converter because current of only one of the phases is being controlled at each link cycle; however, if the input-side filters are large (e.g. when the converter is connected to a three-phase generator with large inductance) the THD may be reduced.

In some instances, the switches may be turned on or off when the voltage on either side of the switches is approximately equal. Transitioning between on state and off state in a switch when the voltage drop across it is approximately zero minimizes energy losses that result from switching. This operation may be referred to herein as “zero voltage switching” (ZVS). In order to facilitate ZVS in an extremely-sparse AC-link power converter, the switches are turned on when they are reverse biased (i.e. when the voltage across them is negative). When a switch is reverse biased it cannot conduct current even if it is turned on. When the voltage across the switch becomes zero, it starts to conduct.

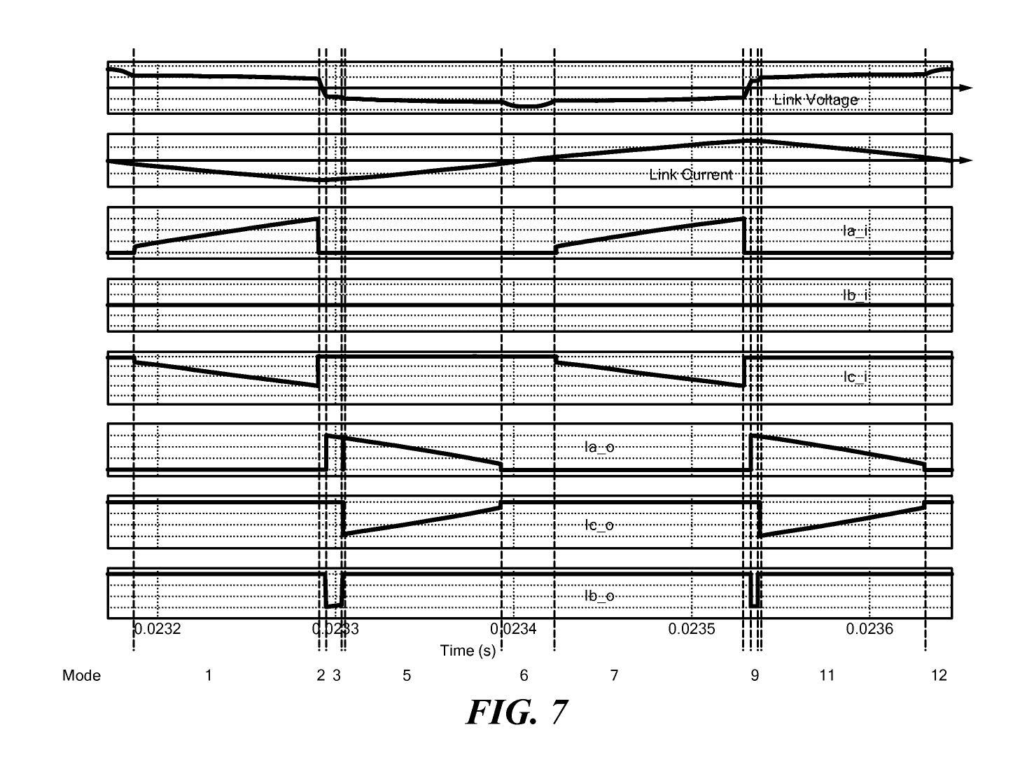

Each link cycle is divided into 12 modes, with 6 power transfer modes and 6 partial resonant modes taking place alternately. The link is energized from the input power source during modes 1 and 7 and is de-energized to the output load during modes 3, 5, 9, and 11. Modes 2, 4, 6, 8, 10, and 12 are partial resonant modes that facilitate zero voltage switching. Each of the 12 modes are described in more detail below with respect to the extremely-sparse AC-link power converter depicted in FIG. 4 and FIGS. 6A-6L. The link voltage, link current, and the input and output currents during each of the 12 modes of operation are shown in the waveform depicted in FIG. 7. It should be noted that the switches may be turned on and off by a control circuit similar to the control circuit described above.

Before the start of mode 1, switches Si7 and Si8 are turned on but do not conduct immediately, because the link voltage is higher than the maximum line-to-line input voltages. When the link voltage becomes equal to the voltage across the maximum instantaneous line-to-line input voltage, switches Si7 and Si8, along with diodes Di1 and Di6 that are connected to the phase pair having the maximum voltage, become forward biased and they start to conduct. Mode 1 begins when switches Si7 and Si8 and diodes Di1 and Di6 start conducting current.

FIG. 6A: Mode 1 (Energizing)

During mode 1, the voltage across the link is positive and equal to the maximum instantaneous line-to-line input voltage. Therefore, the link current (link) increases linearly in a positive direction. Then, once the link is sufficiently charged, switches Si7 and Si8 are turned off.

FIG. 6B: Mode 2 (Partial Resonance)

During mode 2, none of the switches are turned on, and thus do not conduct current. This allows the LC link to resonate, and the link voltage decreases. When the polarity of the link voltage changes, the switches at the output switch bridge that discharges the link during mode 3 are turned on, although they do not conduct current during mode 2. These switches are selected according to the polarity of the output current references. Three switches that can conduct under the desired polarities for the output phase currents may be turned on (So3, So4, and So2 in FIG. 4). However, the turned-on switches do not conduct immediately because they are reverse-biased. When the link voltage becomes equal to one of the output line-to-line voltages (the voltage across output lines C and A), two of the switches that were turned on (Switches So3 and So4 in FIG. 4) along with Do7 and Do8 become forward biased, and mode 3 begins.

FIG. 6C: Mode 3 (De-Energizing)

During mode 3, the voltage across the link is negative and the link current decreases. Current discharges from the link through the switches as described in above with respect to Mode 2. When the average current of the output phase that does not carry the maximum current meets a particular reference (i.e. a threshold current), the switch connected to that phase is turned off, thus beginning resonating mode 4.

FIG. 6D: Mode 4 (Partial Resonance)

During mode 4, the link resonates and its voltage decreases. When the link voltage becomes equal to the other output phase pair (the voltage across output lines B and A), the other two switches (So2 and So4, in FIG. 4) along with Do7 and Do8 become forward biased and begin conducting, thus initiating mode 5.

FIG. 6E: Mode 5 (De-Energizing)

During mode 5, the link inductor discharges through Do7, Do8, So2, and So4, and the link current decreases. Once the energy stored in the link drops to a sufficient amount for the link voltage to swing to a minimum voltage (−Vₘₐₓ)—which is lower than the line-to-line input and output voltages—all the switches are turned off, thus starting resonating mode 6.

FIG. 6F: Mode 6 (Partial Resonance)

The link resonates during mode 6 and the link current decreases until it becomes negative. When the link current becomes goes from positive to negative, switches Si9 and Si10 are turned on, although they do not conduct because they are reversed biased. When the absolute value of the link voltage becomes equal to the maximum line-to-line input voltage, Si9, Si10, and the diodes at the input diode bridge that are connected to the maximum instantaneous line-to-line voltage (Di1 and Di6) are forward biased and begin conducting. This initiates mode 7.

FIG. 6G: Mode 7 (Energizing)

During mode 7, the voltage across the link is negative; therefore the link current decreases and, due to the link current already being negative, the absolute value of the link current increases. Thus, the link is charged in a negative direction. Once the link inductor is sufficiently charged, Si9 and Si10 are turned off, and resonating mode 8 begins.

FIG. 6H: Mode 8 (Partial Resonance)

During mode 8, the link resonates and its voltage increases (although its absolute value decreases). Switches So3 and So4 at the output switch bridge are turned on when the polarity of the link voltage changes (i.e. the link voltage goes from negative to positive); however they are reverse biased and do not conduct until mode 9. These switches (So3 and So4) may be the same as the switches turned on during mode 2. When the link voltage becomes equal to the voltage across output lines A and C, switches So3 and So4 and diodes Do9 and Do10 become forward biased and start to conduct. This initiates mode 9.

FIG. 6I: Mode 9 (De-Energizing)

During mode 9, the voltage across the link is positive, and thus the link current increases. Because the link current is negative, its absolute value decreases. As a result, the link discharges in a negative direction. When the current of the phase that is not carrying the maximum current meets a reference value (i.e. a threshold current value), the switch connected to that phase is turned off. This initiates resonating mode 10.

FIG. 6J: Mode 10 (Partial Resonance)

During mode 10, the link resonates again until the link voltage becomes equal to the voltage across output lines A and B. Then, So2, So4, Do9, and Do10 become forward biased and begin conducting, and mode 11 begins.

FIG. 6K: Mode 11 (De-Energizing)

During mode 11, the link discharges until there is a sufficient amount of energy in the link to swing the voltage of the link to Vₘₐₓ.

FIG. 6L: Mode 12 (Partial Resonance)

During mode 12, the link resonates. The link current increases (and, thus, its absolute value decreases) as it resonates. When the link current changes from negative to positive, Si7 and Si8 are turned on, and the cycle repeats back to mode 1.

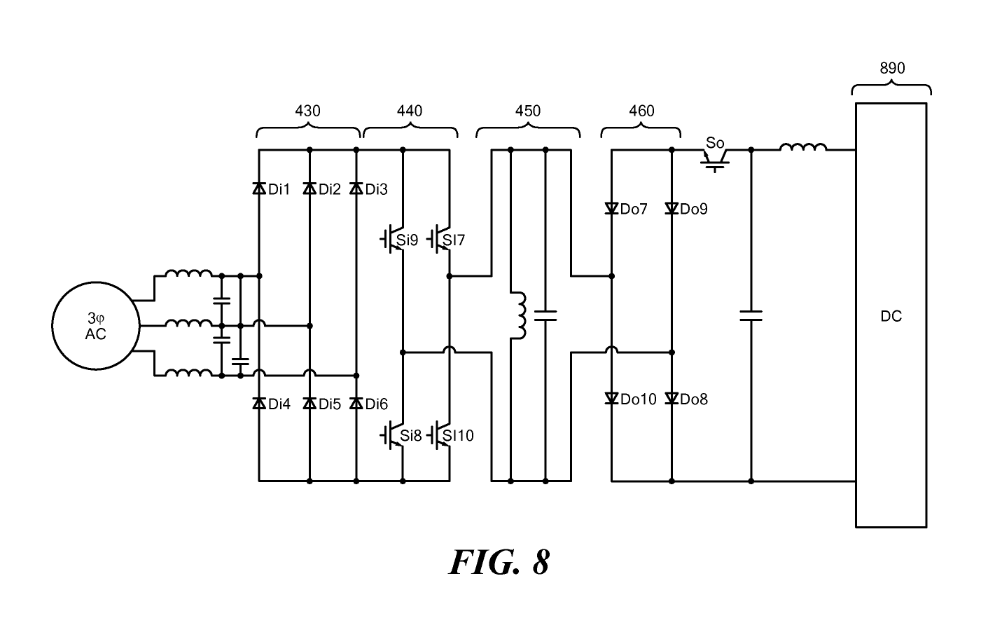

FIG. 8 illustrates a schematic of an extremely-sparse parallel AC-link power converter in an AC-DC configuration in accordance with one or more example embodiments. The input bridge stage 430, input-side crossover switching circuit 440, and the output-side crossover bridge circuit 460 are substantially similar to the previously-described extremely-sparse configuration shown in FIG. 4. (In this and the following embodiments, like reference numerals are used to refer to like elements.) The output switching bridge stage is removed, and a single switch So controls the current that is output to a DC load. The configuration shown in FIG. 8 allows for a unidirectional flow of current from the AC source to the DC load.

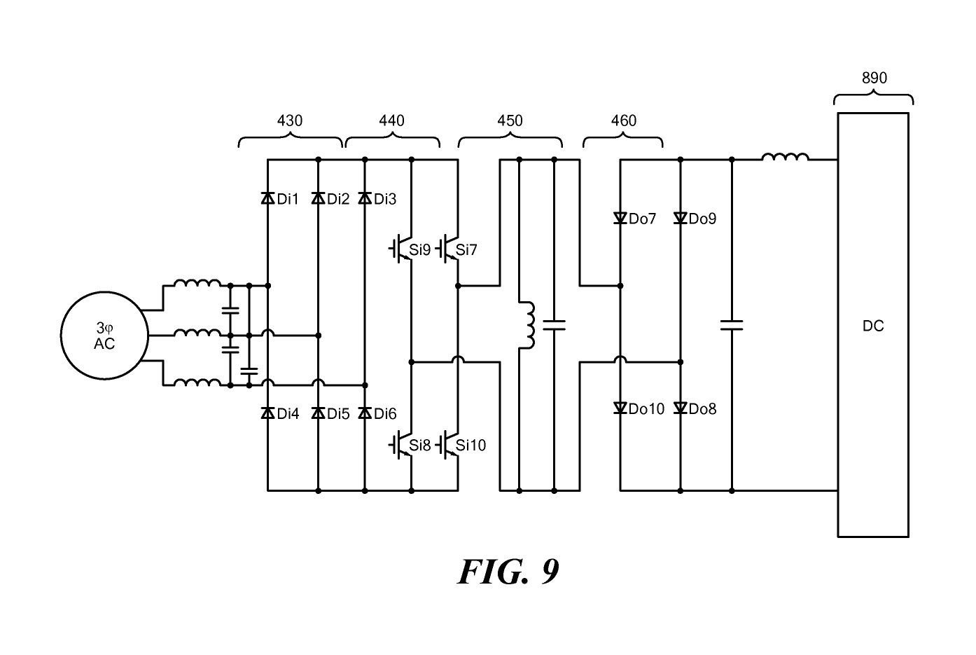

FIG. 9 illustrates a schematic of an extremely-sparse parallel AC-link power converter in an AC-DC configuration with increased output voltage in accordance with one or more example embodiments. The configuration shown in FIG. 9 is similar to the configuration in FIG. 8; however, the output switch So is not present in the configuration shown in FIG. 9. This configuration allows for a unidirectional flow of current from the AC source to the DC load. Because the output switch So is removed in this configuration, the output current cannot be controlled. Thus, the configuration shown in FIG. 9 does not allow for zero voltage switching if the input voltage is higher than the output voltage. However, in some cases, the load voltage is higher than the maximum line-to-line input voltage, and removing the output switch So would not affect the operation of the power converter.

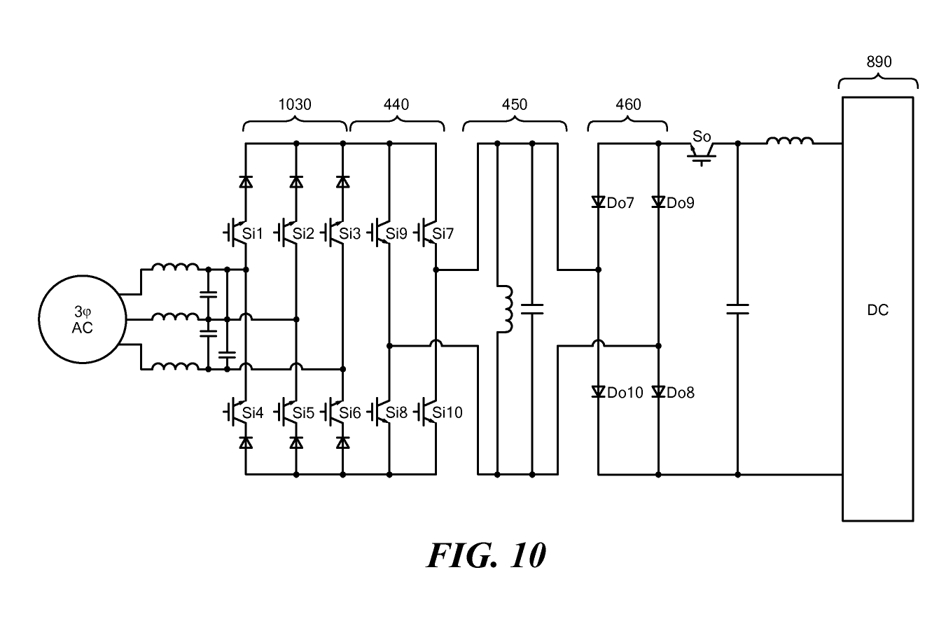

FIG. 10 illustrates a schematic of an extremely-sparse parallel AC-link power converter having a unidirectional conducting input switch bridge in an AC-DC configuration in accordance with one or more example embodiments. The configuration shown in FIG. 10 is similar to the configuration shown in FIG. 8; however, the input bridge circuit is replaced with a controllable input switching bridge circuit 1030. The input switching bridge circuit includes controllable forward-conducting bidirectional-blocking switches Si1-Si6, as shown in FIG. 10. In some embodiments, the input switching bridge circuit may include controllable forward-conducting reverse-blocking switches instead.

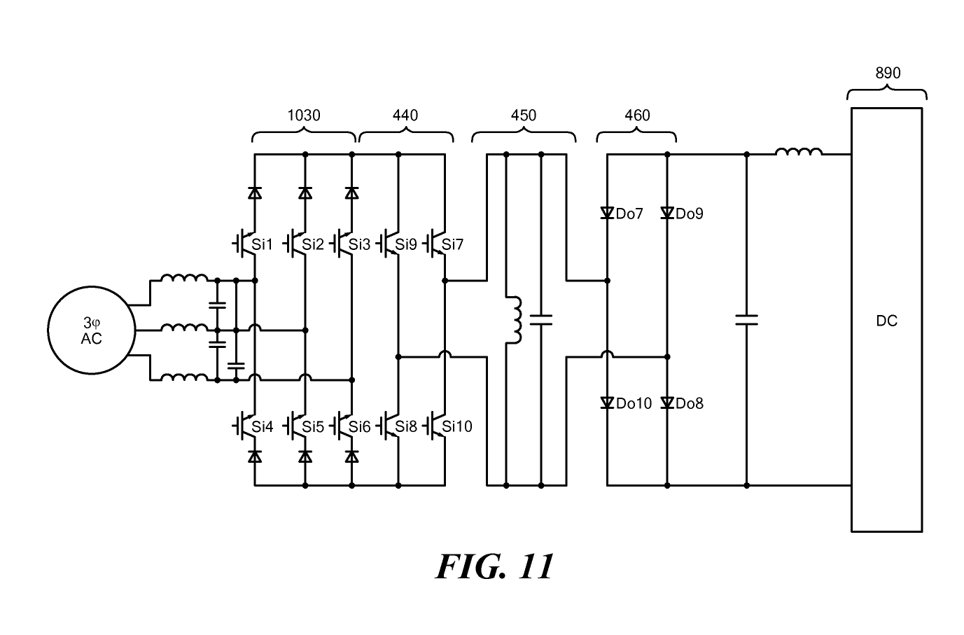

FIG. 11 illustrates a schematic of an extremely-sparse parallel AC-link power converter having a unidirectional conducting input switch bridge in an AC-DC configuration in accordance with one or more example embodiments. The configuration shown in FIG. 11 is similar to the configuration shown in FIG. 9; however, the input bridge circuit is replaced with a controllable input switching bridge circuit 1030. The input switching bridge circuit includes controllable forward-conducting bidirectional-blocking switches Si1-Si6, as shown in FIG. 10. In some embodiments, the input switching bridge circuit may include controllable forward-conducting reverse-blocking switches instead. Because the output switch So is removed in this configuration, the output current cannot be controlled. Thus, the configuration shown in FIG. 11 does not allow for zero voltage switching if the input voltage is higher than the output voltage. However, in some cases, the load voltage is higher than the maximum line-to-line input voltage, and removing the output switch So would not affect the operation of the power converter.

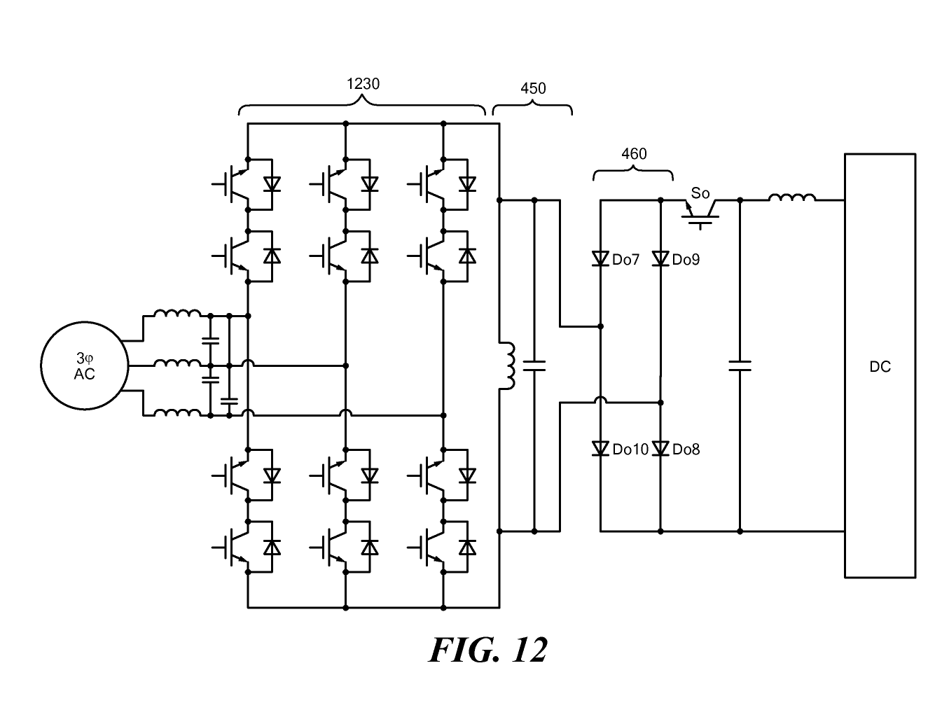

FIG. 12 illustrates a schematic of an extremely-sparse parallel AC-link power converter having a bidirectional-conducting input switch bridge 1230 in an AC-DC configuration in accordance with one or more example embodiments. The configuration shown in FIG. 12 is similar to the configuration shown in FIG. 8; however, the input bridge circuit is replaced with a controllable input switching bridge circuit. The input switching bridge circuit includes controllable bidirectional-conducting bidirectional-blocking switches.

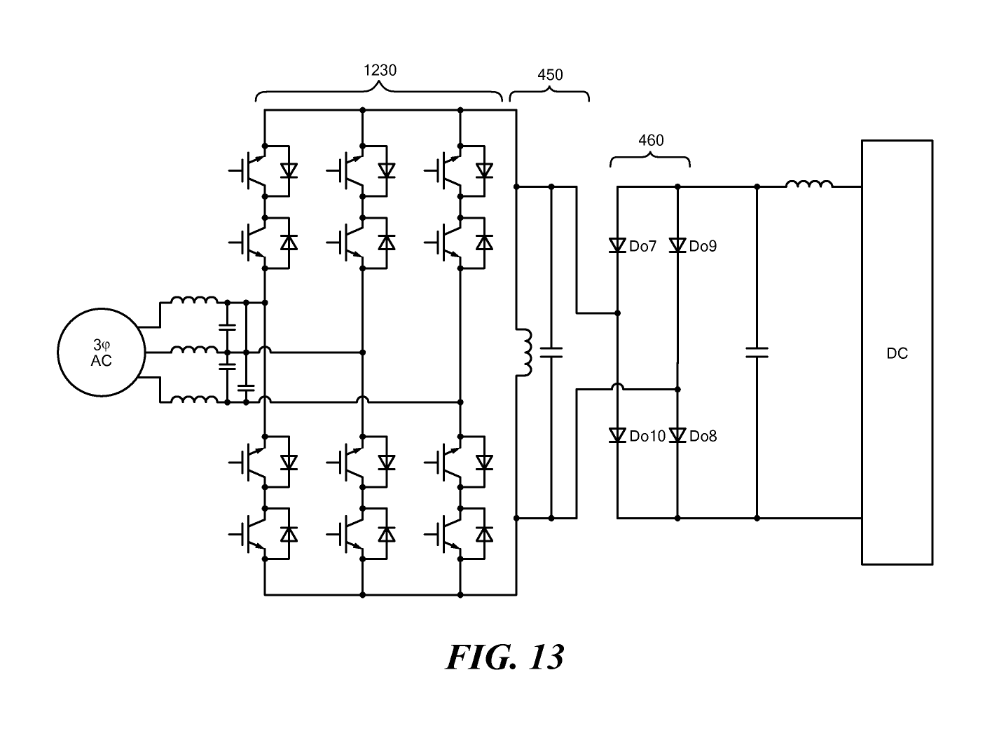

FIG. 13 illustrates a schematic of an extremely-sparse parallel AC-link power converter having a bidirectional-conducting input switch bridge in an AC-DC configuration in accordance with one or more example embodiments. The configuration shown in FIG. 13 is similar to the configuration shown in FIG. 9; however, the input bridge circuit is replaced with a controllable input switching bridge circuit 1230. The input switching bridge circuit includes controllable bidirectional-conducting bidirectional-blocking switches. Because the output switch So is removed in this configuration, the output current cannot be controlled. Thus, the configuration shown in FIG. 13 does not allow for zero voltage switching if the input voltage is higher than the output voltage. However, in some cases, the load voltage is higher than the maximum line-to-line input voltage, and removing the output switch So would not affect the operation of the power converter.

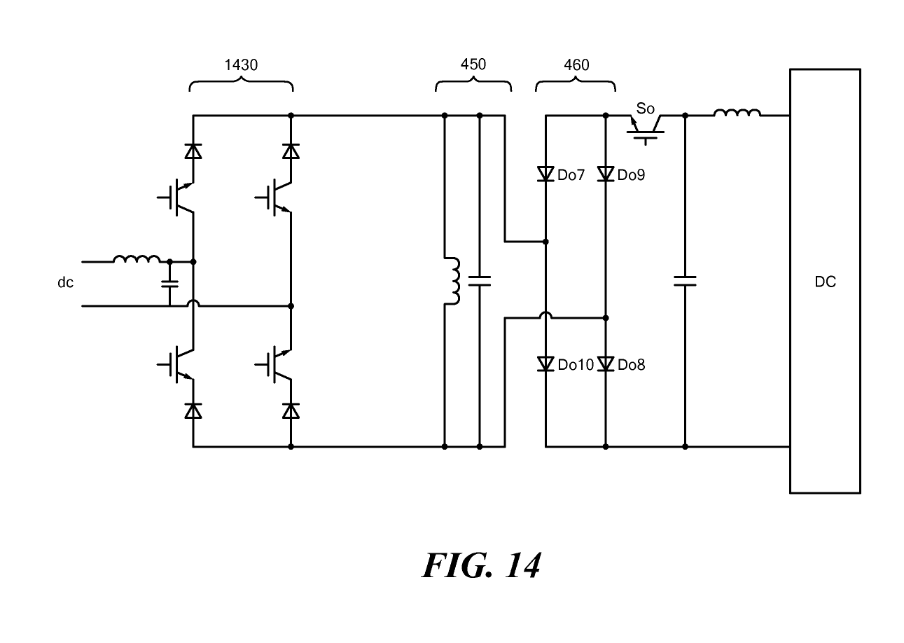

FIG. 14 illustrates a schematic of an extremely-sparse parallel AC-link power converter without an input-side crossover switch bridge in a DC-DC configuration in accordance with one or more example embodiments. The configuration shown in FIG. 14 includes an input switching bridge circuit 1430, an AC-link 450, an output-side crossover bridge circuit 460, and an output switch So. The input switching bridge circuit includes four forward-conducting reverse-blocking switching devices. The output-side crossover bridge circuit includes four reverse-blocking devices Do7-Do10 arranged in a bridge configuration. The output switch So controls the output current to the DC load to allow for zero voltage switching.

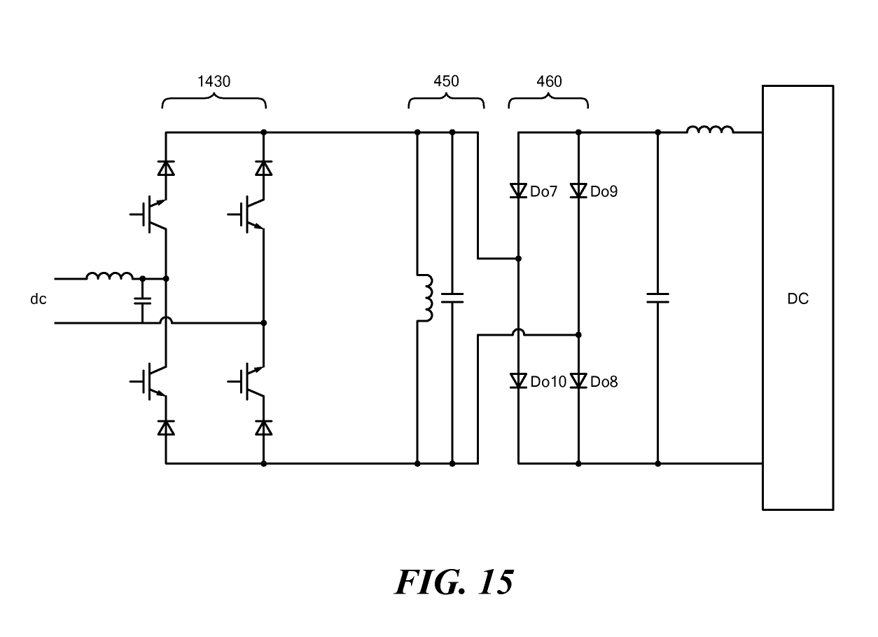

FIG. 15 illustrates a schematic of an extremely-sparse parallel AC-link power converter without an input-side crossover switch bridge with increased output voltage in a DC-DC configuration in accordance with one or more example embodiments. The configuration shown in FIG. 15 includes an input switching bridge circuit 1430, an AC-link 450, and an output-side crossover bridge circuit 460. The input switching bridge circuit includes four forward-conducting reverse-blocking switching devices. The output-side crossover bridge circuit includes four reverse-blocking devices Do7-Do10 arranged in a bridge configuration. The output current to the DC load cannot be controlled, so this configuration does not allow for zero voltage switching if the input voltage is higher than the output voltage.

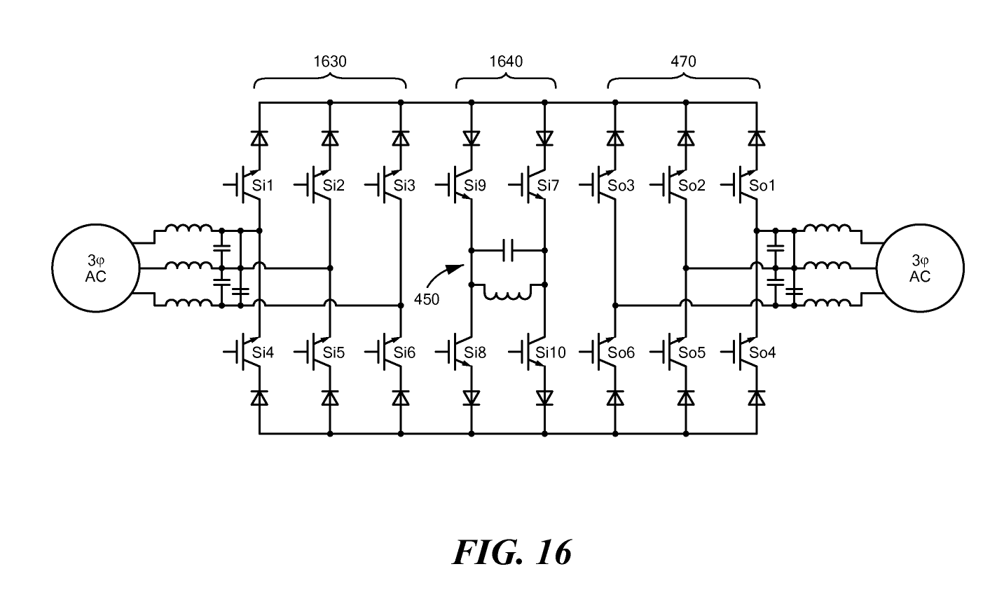

FIG. 16 illustrates a schematic of an extremely-sparse parallel AC-link power converter with bidirectional power flow in an AC-AC configuration in accordance with one or more example embodiments. The configuration shown in FIG. 16 may be controlled to provide a bidirectional flow of power, similarly to the universal power converter depicted in FIG. 1. The AC-link is provided between four switching devices that form an intermediate crossover switching circuit. This configuration is similar to the sparse configuration shown in FIG. 2; however, four switches are removed by combining the input-side crossover switching circuit and the output-side crossover switching circuit to form the intermediate crossover switching circuit 1640 without losing the versatility and functionality provided by the partially resonant AC-link universal power converter. The input switching bridge circuit, the intermediate crossover switching circuit, and the output switching bridge circuit include forward-conducting bidirectional-blocking switching devices.

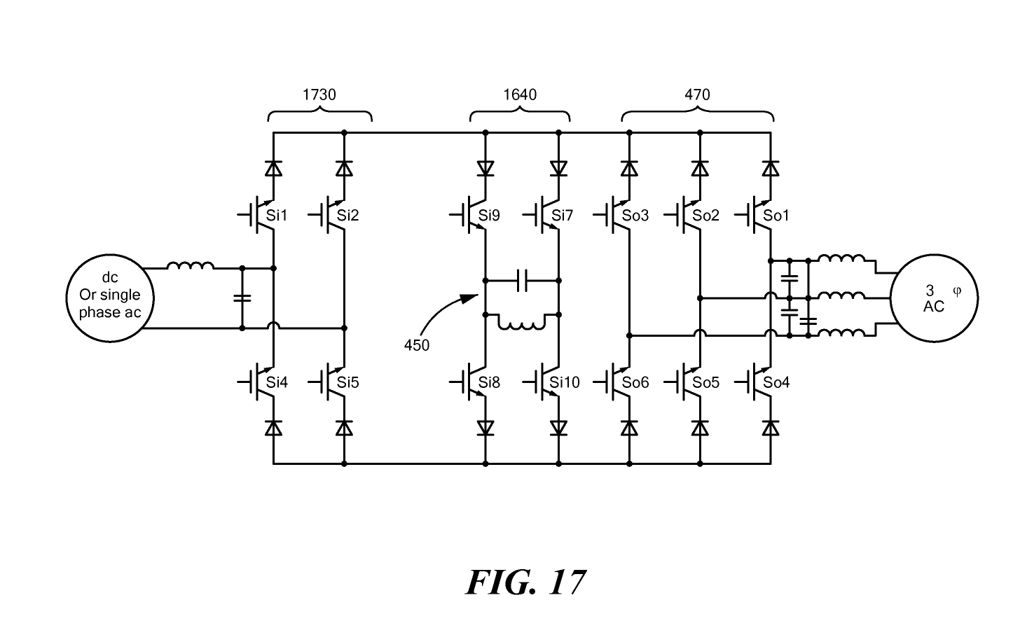

FIG. 17 illustrates a schematic of an extremely-sparse parallel AC-link power converter with bidirectional current flow in a DC-AC configuration in accordance with one or more example embodiments. The configuration shown in FIG. 17 is substantially similar to the configuration shown in FIG. 16; however, the input switching bridge circuit 1730 is reduced from six to four switches. In this configuration, the power source may be either DC or single-phase AC.

It will be appreciated that the various features of the embodiments described herein can be combined in a variety of ways. For example, a feature described in conjunction with one embodiment may be included in another embodiment even if not explicitly described in conjunction with that embodiment.

The present invention has been described in conjunction with certain preferred embodiments. It is to be understood that the invention is not limited to the exact details of construction, operation, exact materials or embodiments shown and described, and that various modifications, substitutions of equivalents, alterations to the compositions, and other changes to the embodiments disclosed herein will be apparent to one of skill in the art.

What is claimed is:

1. A power conversion device comprising:
at least one input bridge stage comprising a plurality of uncontrollable forward-conducting reverse-blocking devices, wherein the at least one input bridge stage is configured to be coupled to a power source;
a link stage comprising at least one reactive component of a partially resonant circuit, wherein the partially resonant circuit is configured for alternating-current (AC) operation;
at least one output switch bridge stage comprising a plurality of controllable forward-conducting forward-blocking switching devices or controllable forward-conducting bidirectional-blocking switching devices, wherein the at least one output switch bridge stage is configured to be coupled to a load and control current output to the load;
a crossover switching circuit coupling the at least one input bridge stage to the link stage, wherein the crossover switching circuit comprises a plurality of controllable forward-conducting forward-blocking switching devices or controllable forward-conducting bidirectional-blocking switching devices, and wherein the crossover switching circuit is configured to control current from the at least one input bridge stage to the link stage and allow the link current to be alternating; and
a crossover bridge circuit coupling the link stage to the at least one output switch bridge stage, wherein the crossover bridge circuit comprises a bridge of uncontrollable forward-conducting reverse-blocking devices, and wherein the crossover bridge circuit is configured to allow the link current to be alternating.

2. The device of claim 1, wherein the link stage comprises at least one reactive component of a partially resonant parallel inductor-capacitor (LC) circuit.

3. The device of claim 2, wherein the at least one reactive component of a partially resonant parallel LC circuit comprises a capacitor, and wherein the partially resonant parallel LC circuit is formed by capacitance of the capacitor together with parasitic inductance of the capacitor.

4. The device of claim 2, wherein the at least one reactive component of a partially resonant parallel LC circuit comprises an inductor, and wherein the partially resonant parallel LC circuit is formed by inductance of the inductor together with parasitic capacitance of the inductor.

5. The device of claim 2, wherein the partially resonant parallel LC circuit comprises an inductor connected in parallel with a capacitor, and wherein the partially resonant parallel LC circuit is formed by inductance of the inductor together with capacitance of the capacitor.

6. The device of claim 1, wherein the at least one reactive component of a partially resonant circuit comprises a galvanic isolation device, wherein the partially resonant circuit further comprises a first capacitive device connected in parallel to an input of the galvanic isolation device and a second capacitive device connected in parallel to an output of the galvanic isolation device, and wherein the partially resonant circuit is formed by inductance of the galvanic isolation device together with capacitance of the first capacitive device and the second capacitive device.

7. The device of claim 1, wherein the power source comprises at least one of the following: a three-phase AC power source, a single-phase AC source, a DC source, and a polyphase AC-source.

8. The device of claim 1, wherein the partially resonant circuit has a resonant frequency that is greater than a frequency of the power source.

9. The device of claim 1, wherein the at least one input bridge stage comprises a diode or a bridge of an even number of diodes configured to form a bridge circuit.

10. The device of claim 9, wherein the at least one input bridge stage comprises six diodes configured to form a three-phase bridge circuit.

11. The device of claim 1, wherein the output crossover bridge circuit comprises a bridge of four diodes configured to form a bridge circuit.

12. A power conversion circuit comprising:
a first diode bridge circuit comprising one diode or an even number of diodes configured to form a bridge circuit;
a partially resonant link circuit comprising at least one capacitive element and at least one inductive element connected in parallel;
a first switch bridge circuit comprising one switch or an even number of switches configured to form a switched bridge circuit;
a second switch bridge circuit coupling the first diode bridge circuit to the partially resonant link circuit, wherein the second switch bridge comprises four switches configured to form a switched bridge circuit; and
a second diode bridge circuit coupling the partially resonant link circuit to the first switch bridge circuit, wherein the second diode bridge circuit comprises four diodes configured to form a bridge circuit.

13. The circuit of claim 12, wherein the first diode bridge circuit comprises six diodes.

14. The circuit of claim 12, wherein the first switch bridge circuit comprises six switches.

15. The circuit of claim 12, further comprising a power source connected to the first diode bridge circuit.

16. The circuit of claim 12, further comprising a load connected to the first switch bridge circuit.

17. The circuit of claim 12, wherein the at least one capacitive element is a capacitor.

18. The circuit of claim 12, wherein the at least one inductive element is an inductor.

19. The circuit of claim 12, wherein the at least one inductive element is a single-phase transformer.

20. The circuit of claim 12, wherein each switch of the first switch bridge circuit and the second switch bridge circuit comprises a field effect transistor (FET), an Insulated Gate Bipolar Transistor (IGBT), a diode in series with a field effect transistor (FET), or a diode in series with an Insulated Gate Bipolar Transistor (IGBT).

21. A method of operating a power conversion circuit comprising an input bridge stage, a link stage, an output switch bridge stage, a crossover switching circuit coupling the input bridge stage to the link stage, and a crossover bridge circuit coupling the link stage to the output switch bridge stage, wherein the method comprises:
operating the crossover switching circuit to charge a reactive component of the link stage by turning on the switches of the crossover switching circuit to facilitate a positive current flow;
blocking current flow from the input bridge stage to the link stage by turning off one or more switches of the crossover switching circuit to allow the link stage to resonate; and
operating the output switch bridge stage to discharge the reactive component of the link stage by turning on one or more switches of the output switch bridge stage.

22. The method of claim 21, further comprising:
operating the crossover switching circuit to charge a reactive component of the link stage by turning on the switches of the crossover switching circuit to facilitate a negative current flow.

23. The method of claim 21, wherein turning on one or more switches of the output switch bridge stage is performed in response to a voltage of the link stage being zero.

24. A power conversion device comprising:
at least one input bridge stage comprising a plurality of uncontrollable forward-conducting reverse-blocking devices, wherein the at least one input bridge stage is configured to be coupled to a power source;
a link stage comprising at least one reactive component of a partially resonant circuit, wherein the partially resonant circuit is configured for alternating-current (AC) operation;
a crossover switching circuit coupling the at least one input bridge stage to the link stage, wherein the crossover switching circuit comprises a plurality of controllable forward-conducting forward-blocking devices or controllable forward-conducting bidirectional-blocking devices, and wherein the crossover switching circuit is configured to control current from the at least one input bridge stage to the link stage and allow the link current to be alternating; and
a crossover bridge circuit coupling the link stage to a DC load, wherein the crossover bridge circuit comprises a bridge of uncontrollable forward-conducting reverse-blocking devices, and wherein the crossover bridge circuit is configured to allow the link current to be alternating.

25. The power conversion device of claim 24, further comprising at least one output switch configured to be coupled between the crossover bridge circuit and the DC load and configured to control current output to the load.

26. A power conversion device comprising:
at least one input bridge stage comprising a plurality of controllable forward-conducting reverse-blocking or controllable forward-conducting bidirectional-blocking switching devices, wherein the at least one input bridge stage is configured to be coupled to a power source;
a link stage comprising at least one reactive component of a partially resonant circuit, wherein the partially resonant circuit is configured for alternating-current (AC) operation;
a crossover switching circuit coupling the at least one input bridge stage to the link stage, wherein the crossover switching circuit comprises a plurality of controllable forward-conducting forward-blocking or controllable forward-conducting bidirectional-blocking switching devices, and wherein the crossover switching circuit is configured to control current from the at least one input bridge stage to the link stage and allow the link current to be alternating; and
a crossover bridge circuit coupling the link stage to a DC load, wherein the crossover bridge circuit comprises a bridge of uncontrollable forward-conducting reverse-blocking devices, and wherein the crossover bridge circuit is configured to allow the link current to be alternating.

27. The power conversion device of claim 26, further comprising at least one output switch configured to be coupled between the crossover bridge circuit and the a DC load and configured to control current output to the DC load;

28. A power conversion device comprising:
at least one input bridge stage comprising a plurality of controllable bidirectional-conducting bidirectional-blocking switching devices, wherein the at least one input bridge stage is configured to be coupled to a power source;
a link stage comprising at least one reactive component of a partially resonant circuit, wherein the partially resonant circuit is configured for alternating-current (AC) operation; and
a crossover bridge circuit coupling the link stage to a DC load, wherein the crossover bridge circuit comprises a bridge of uncontrollable forward-conducting reverse-blocking devices, and wherein the crossover bridge circuit is configured to allow the link current to be alternating.

29. The power conversion device of claim 28, further comprising at least one output switch configured to be coupled between the crossover bridge circuit and the DC load and configured to control current output to the DC load.

30. A power conversion device comprising:
a link stage comprising at least one reactive component of a partially resonant circuit, wherein the partially resonant circuit is configured for alternating-current (AC) operation;
a crossover switching circuit coupling a DC power source to the link stage, wherein the crossover switching circuit comprises a plurality of controllable forward-conducting forward-blocking or controllable forward-conducting bidirectional-blocking switching devices, and wherein the crossover switching circuit is configured to control current from an input source to the link stage and allow the link current to be alternating; and
a crossover bridge circuit coupling the link stage to a DC load, wherein the crossover bridge circuit comprises a bridge of uncontrollable forward-conducting reverse-blocking devices, and wherein the crossover bridge circuit is configured to allow the link current to be alternating.

31. The power conversion device of claim 30, further comprising at least one output switch configured to be coupled between the crossover bridge circuit and the DC load and configured to control current output to the DC load.

32. A power conversion device comprising:
at least one input switch bridge stage comprising a plurality of controllable forward-conducting reverse-blocking or controllable forward-conducting bidirectional-blocking switching devices, wherein the at least one input bridge stage is configured to be coupled to a power source;
a link stage comprising at least one reactive component of a partially resonant circuit, wherein the partially resonant circuit is configured for alternating-current (AC) operation;
at least one output switch bridge stage comprising a plurality of controllable forward-conducting forward-blocking switching devices or controllable forward-conducting bidirectional-blocking switching devices, wherein the output switch bridge stage is configured to be coupled to a load and control current output to the load; and
an intermediate crossover switching circuit coupling the at least one input switch bridge stage to the link stage and coupling the link stage to the at least one output switch bridge stage, wherein the intermediate crossover switching circuit comprises a plurality of forward-conducting bidirectional-blocking switching devices, and wherein the intermediate crossover switching circuit is configured to allow the link current to be alternating.
